(19) United States
(12) Patent Application Publication
(10) Pub. No.: US 2005/0043173 A1
(43) Pub. Date: Feb. 24, 2005

(54) Image recording material

(75) Inventor: Tomotaka Tsuchimura, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/921,860

(22) Filed: Aug. 20, 2004

(30) Foreign Application Priority Data
Aug. 22, 2003 (JP) 2003-298432

(51) Int. Cl. B41M 5/20

(52) U.S. Cl. 503/201

(57) ABSTRACT

The heat mode image recording material of the present invention comprises an infrared absorbent (A), and a polymer (B) comprising a polyfunctional monomer component. The material can be exposed to an infrared laser, whereby an image can be formed thereon. The heat mode image recording material of the invention has superior film-formability and superior film strength, and is useful for a the recording layer of a planographic printing plate precursor having wide development latitude and excellent scratch resistance.

### CROSS-REFERENCE TO RELATED APPLICATION

This application claims priority under 35 USC 119 from Japanese Patent Application No. 2003-298432, the disclosure of which is incorporated by reference herein.

### BACKGROUND OF THE INVENTION

1. Field of the Invention

The present invention relates to an image recording material. More specifically, the invention relates to an image recording material useful as a recording layer of an infrared-laser-applicable planographic printing plate precursor for a so-called CTP (Computer To Plate), from which a printing plate can be directly formed by scanning using an infrared laser based on digital signals from a computer or the like.

2. Description of the Related Art

The development of lasers for planographic printing in recent years has been remarkable. In particular, high-power, small-sized solid lasers and semiconductor lasers that emit near-infrared and infrared rays have become easily obtainable. These lasers are very useful as exposure light sources when forming printing plates directly from digital data of computers or the like.

Materials which can be used for positive type planographic printing plate precursors applicable for infrared lasers include, as essential components, a binder resin soluble in an aqueous alkaline solution (hereinafter referred to where appropriate as an “alkali-soluble resin”), and an infra red dye which absorbs light to generate heat. When an image is formed in a positive type planographic printing plate precursor, the infra red dye interacts with the binder resin in its unexposed portions (image portions) so as to function as a dissolution inhibitor which can substantially reduce the solubility of the binder resin. On the other hand, in its exposed portions (non-image portions), interaction of the infra red dye with the binder resin is weakened by the heat generated. Consequently, an exposed portion can turn into a state in which it can be dissolved in an alkaline developer, so that an image is formed thereon.

However, insofar as infrared-laser-applicable positive planographic printing plate precursor materials are concerned, differences in the degree of resistance against dissolution in a developer between unexposed portions (image portions) and exposed portions (non-image portions) therein, that is, differences in development latitude have not yet been sufficient under various conditions of use. Thus, problems have occurred insofar that, with changes in conditions of use of materials, materials have tended to be either excessively developed or inadequately developed.

Such problems stem from fundamental differences in plate-making mechanisms between infrared-laser-applicable positive type planographic printing plate precursor materials and positive type planographic printing plate precursor materials from which printing plates are made up by exposure to ultra violet rays.

In other words, positive type planographic printing plate precursor materials from which printing plates are made up by exposure to ultra violer rays each include, as essential components, a binder resin soluble in an aqueous alkaline solution and an onium salt, or a quinonediazide compound. This onium salt or quinonediazide compound not only interacts with the binder resin in unexposed portions (image portions) to function as a dissolution inhibitor, but in exposed portions (non-image portions) it is also decomposed by light and generates an acid to function as a dissolution promoter. In this way, the onium salt, or the quinonediazide compound, performs dual functions.

On the other hand, in infrared-laser-applicable positive type planographic printing plate precursor materials, the infra red dye functions only as a dissolution inhibitor of unexposed portions (image portions), and does not promote the dissolution of exposed portions (non-image portions). Furthermore, heat generated in exposed portions near the interface between the photosensitive layer and the support diffuses to the support. Thus, in some cases heat may not be effectively used for forming images. As a result, the materials of this type have a drawback insofar that a film residue is easily generated. Accordingly, demands have been made for infrared-laser-applicable positive type planographic printing plate precursor materials which have both a high sensitivity and a wide development latitude.

When using an infrared-laser-applicable positive type planographic printing plate precursor, if the surface state of the unexposed portions of the plate precursor is slightly changed by human finger touching the surface or some other action, the affected unexposed portions (image portions) are dissolved by development to generate marks like scars. As a result, the plate precursor has problems in that the printing resistance thereof deteriorates and the ink-acceptability thereof worsens.

In order to solve such problems, there have been suggested a method of using a binder resin having high solubility in an alkaline developer but exhibiting alkali resistance by thermal treatment (see, for example, Japanese Patent Application, Laid-Open, No. 2001-520953), and a method of adding a compound having an amino group to exhibit high reactivity, such as a melamine derivative (see, for example, JP-A, Laid-Open, No. 11-202481). However, in these methods, it is likely that long time is required for thermal treatment, or that the state of the recording layer before development is unstable, thereby lowering the storage stability of the recording layer.

Also suggested is a technique of incorporating an organic acid, such as polyacrylic acid, into a positive type photosensitive composition comprising a photothermal conversion material and an alkali-soluble resin, in order to improve the strength of the film made from the composition (see, for example, JP-A No. 10-282643). However, in consideration of further improvement in the sensitivity of photosensitive layers, it is desired that the strength of the film be further improved.

There is also disclosed a technique of incorporating a methyl methacrylate-(meth)acrylic acid copolymer into a positive type photosensitive composition comprising a photothermal conversion material and Novolak resin (see, for example, JP-A No. 2001-324808). However, this example is not yet adequate in terms of maintaining the sensitivity of the film while improving the strength thereof.

### SUMMARY OF THE INVENTION

In light of the above-mentioned problems, an object of the present invention is to provide an image recording material which has excellent film-formability and superior film strength, and which is useful as a recording layer of a planographic printing plate precursor having wide development latitude and superior scratch resistance.

As a result of the investigation by the inventors, it has been discovered that the above-mentioned object can be attained by using a polymer comprising a polyfunctional monomer component. Thus, the invention has been made using this polymer.

That is, the image recording material of the invention comprises an infrared absorbent (A), and a polymer (B) comprising a polyfunctional monomer component (hereinafter referred to a “specific polymer”), the material being modified when exposed by an infrared laser, whereby an image can be formed thereon.

The specific polymer according to the invention is used as a binder component in the image recording material of the invention. The most preferable embodiment of the specific polymer according to the invention comprises, as a copolymerization component, a monomer component other than the polyfunctional monomer from the viewpoint of the dispersibility of the three-dimensional crosslinked structure in the composition.

In the image recording material for a planographic printing plate precursor and the like, a widely used polymer compound having phenolic hydroxyl groups exhibits image-formability by both the effect of suppressing dissolution of the film made from this material by interaction between the hydroxyl groups, and the effect of canceling this dissolution-suppressing effect thereof with heat. However, due to this interaction, the flexibility of the film deteriorates and displays brittleness. Moreover, it appears that the molecules of the polymer compound have alkali-soluble channels which result from association between a large number of alkali-soluble functional groups in the molecules, so that the polymer compound has low resistance against an aqueous alkaline solution.

Although the mechanism of the effect of the invention is unclear, it is believed that the specific polymer of the invention having three-dimensional structure based on the polyfunctional monomer causes the film-formability of the recording material and the strength of the film made from this material to be improved, thereby suppressing the generation of cracks caused by brittleness of the film.

Moreover, it is believed that when the specific polymer is applied to the recording layer of a positive planographic printing plate precursor or some other element, suppression of the generation of the cracks, which cracks result from the brittleness, makes it possible to exhibit superior scratch resistance.

It is also believed that since the specific polymer blocks the alkali-soluble channels of the polymer compound, which has the phenolic hydroxyl groups or other acidic groups, resistance of the recording material against aqueous an alkaline solution and the development latitude thereof are improved.

When the image recording material of the invention is used as a recording layer of a positive type planographic printing plate precursor as described above, in the unexposed portions (image portions) a film excellent in resistance against alkaline developer is formed while the exposed portions (non-image portions) are rapidly removed by action of the alkaline developer, to suppress undesired generation of film residues. Accordingly, the positive type planographic printing plate precursor of the invention has excellent scratch resistance and wide development latitude.

According to the invention, an image recording material can be provided which has excellent film-formability and superior film strength, and which is useful as a recording layer of a planographic printing plate precursor having wide development latitude and superior scratch resistance.

### DETAILED DESCRIPTION OF THE INVENTION

The image recording material of the present invention comprises an infrared absorbent (A), and a polymer (B) comprising a polyfunctional monomer component (i.e., a specific polymer). First, the specific polymer related to the invention will be described in detail.

[Polymer (B) Comprising a Polyfunctional Monomer Component]

(Polyfunctional Monomer)

The polyfunctional monomer component which constitutes the specific polymer related to the invention is preferably a compound having 2 or more terminal ethylenic unsaturated groups which can undergo radical polymerization reaction (examples of the ethylenic unsaturated groups including acryloyl, methacryloyl, vinyl and ally groups), and is more preferably a compound having 2 groups selected from the terminal ethylenic unsaturated groups.

The polyfunctional monomer component is preferably a compound represented by the following general formula (I): 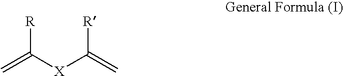
wherein R and R′ each independently represent a hydrogen atom or a methyl group; and X represents a bivalent linking group.

Specific examples of the bivalent linking group represented by X in the general formula (I) include:
a normal, branched or cyclic alkyl group having 1 to 20 carbon atoms, a normal, branched or cyclic alkenyl group having 2 to 20 carbon atoms, an alkynyl group having 2 to 20 carbon atoms, a (monocyclic or heterocyclic) aryl group having 6 to 20 carbon atoms, —C(═O)N—, —OC(═O)N—, —NC(═O)N—, —SC(═O)N—, —C(═S)—, —OC(═S)—, —NC(═S)—, —SC(═S)—, —O—, —C(═O)O—, —C(═O)—, —S—, —SO₂—, —SO₃—, —SO₂N—, —NH—, —NR¹, —NAr—, —N═N—, —N(═NH)N—, and combination of two or more types of these groups, wherein R¹ represents an alkyl, alkenyl or alkynyl, Ar represents a (monocyclic or heterocyclic) aryl.

The bivalent linking group (organic group) may further have a substituent. Examples of the substituent which can be introduced include normal, branched or cyclic alkylene groups having 1 to 20 carbon atoms, normal, branched or cyclic alkenylene groups having 2 to 20 carbon atoms, alkynyl groups having 2 to 20 carbon atoms, arylene groups having 6 to 20 carbon atoms, acyloxy groups having 1 to 20 carbon atoms, alkoxycarbonyloxy groups having 2 to 20 carbon atoms, aryloxycarbonyloxy groups having 7 to 20 carbon atoms, carbamoyloxy groups having 1 to 20 carbon atoms, carbamide groups having 1 to 20 carbon atoms, sulfonamide groups having 1 to 20 carbon atoms, carbamoyl groups having 1 to 20 carbon atoms, sulfamoyl groups having 0 to 20 carbon atoms, alkoxy groups having 1 to 20 carbon atoms, aryloxy groups having 6 to 20 carbon atoms, aryloxycarbonyl groups having 7 to 20 carbon atoms, alkoxycarbonyl groups having 2 to 20 carbon atoms, N-acylsulfamoyl groups having 1 to 20 carbon atoms, N-sulfamoylcarbamoyl groups having 1 to 20 carbon atoms, alkylsulfonyl groups having 1 to 20 carbon atoms, arylsulfonyl groups having 6 to 20 carbon atoms, alkoxycarbonylamino groups having 2 to 20 carbon atoms, aryloxycarbonylamino groups having 7 to 20 carbon atoms, amino groups having 0 to 20 carbon atoms, imino groups having 1 to 20 carbon atoms, ammonio groups having 3 to 20 carbon atoms, a carboxyl group, a sulfo group, an oxy group, a mercapto group, alkylsulfinyl groups having 1 to 20 carbon atoms, arylsulfinyl groups having 6 to 20 carbon atoms, alkylthio groups having 1 to 20 carbon atoms, arylthio groups having 6 to 20 carbon atoms, ureido groups having 1 to 20 carbon atoms, heterocyclic groups having 2 to 20 carbon atoms, acyl groups having 1 to 20 carbon atoms, sulfamoylamino groups having 0 to 20 carbon atoms, silyl groups having 2 to 20 carbon atoms, a hydroxyl group, an isocyanate group, an isocyanide group, halogen atoms (such as fluorine, chlorine and bromine atoms), a cyano group, a nitro group, and onium groups.

A more preferable example of the polyfunctional monomer component is a compound represented by the following general formula (II): 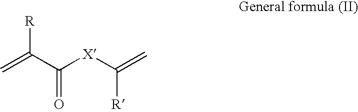
wherein R and R′ each independently represent a hydrogen atom or a methyl group; and X′ represents a bivalent linking group.

Specific examples of the bivalent linking group represented by X′ in the general formula (II) are equivalent to the specific examples of X in the general formula (I).

Another more preferable example of the polyfunctional monomer component is a compound represented by the following general formula (III): 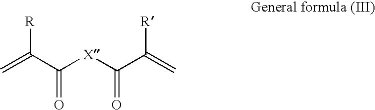
wherein R and R′ each independently represent a hydrogen atom or a methyl group; and X″ represents a bivalent linking group.

Specific examples of the bivalent linking group represented by X″ in the general formula (III) are equivalent to the specific examples of X in the general formula (I).

Still another more preferable example of the polyfunctional monomer component is a compound represented by the following general formula (IV): 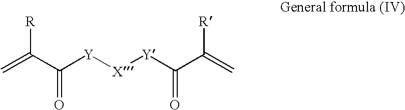
wherein R and R′ each independently represent a hydrogen atom or a methyl group; X′″ represents a bivalent linking group; and Y and Y′ each independently represent an oxygen atom or NR² wherein R² represents a hydrogen atom or an alkyl group.

Specific examples of the bivalent linking group represented by X′″ in the general formula (IV) are equivalent to the specific examples of X in the general formula (I).

Particularly preferable examples of the polyfunctional monomer are illustrated below. In the invention, however, the polyfunctional monomer is not limited to these compounds.

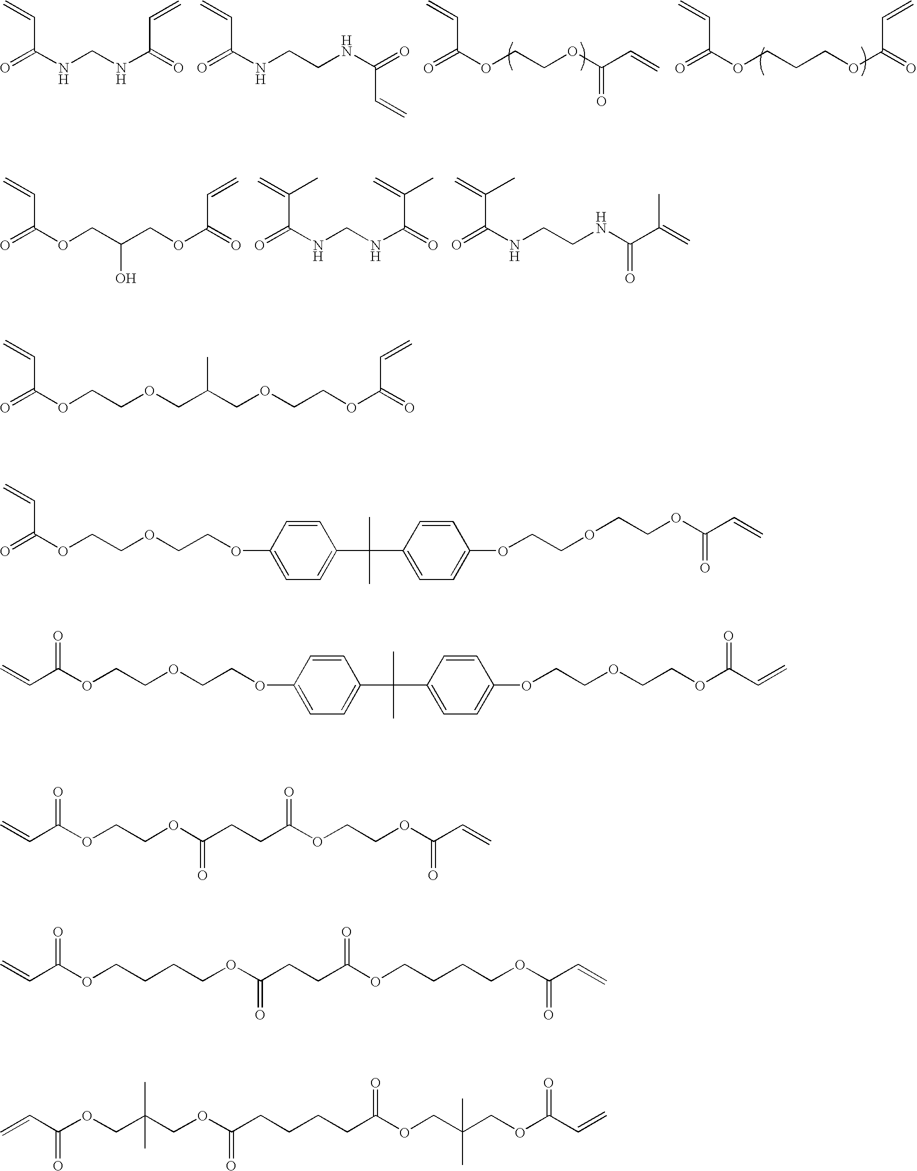

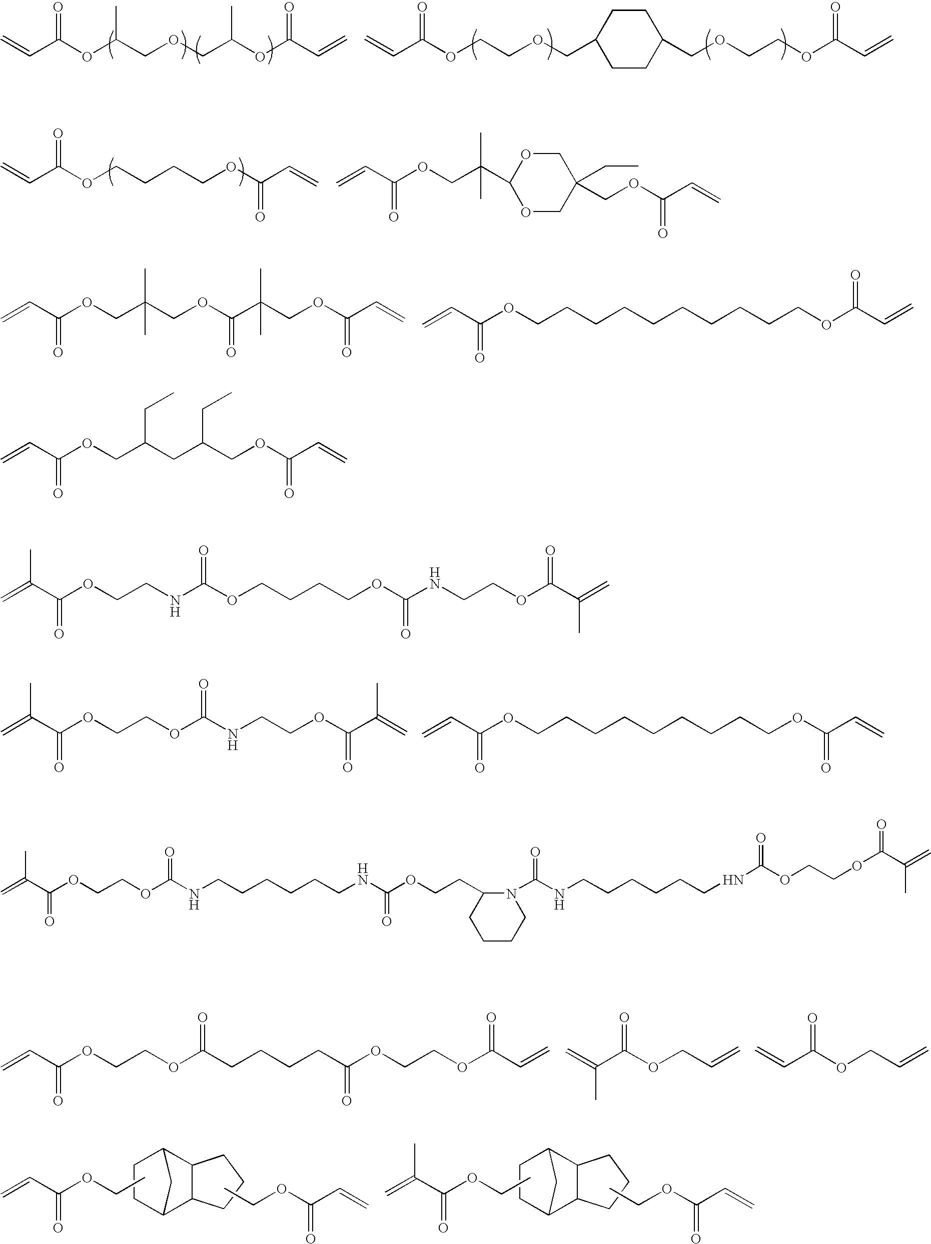

Each type of the polyfunctional monomers may be used alone or in combination of two or more thereof.

The specific polymer can be obtained by homopolymerizing the above-mentioned polyfunctional monomer or copolymerizing the monomer with a different copolymerization component. The specific polymer in the invention is preferably a copolymer made from the polyfunctional monomer with a different copolymerization component.

In the invention, the homopolymer of the polyfunctional monomer may be used in the form of a mixture thereof with at least one different alkali-soluble resin. About the blend ratio between the homopolymer of the polyfunctional monomer and the different alkali-soluble resin(s) in this case, it is preferable that the homopolymer of the polyfunctional monomer is contained at a ratio of 2.0 to 70% by mass, more preferably at a ratio of 5.0 to 60% by mass, with respect to the total amount of the alkali-soluble resin(s).

Examples of the different copolymerization component other than the polyfunctional monomer include monomers in the following items (1) to (6):
(1) A phenol group (—Ar—OH)
(2) Sulfonamide groups (—SO₂NH—R)
(3) Active imide groups (—SO₂NHCOR—, —SO₂NHSO₂R, and —CONHSO₂R)
(4) A carboxylic acid group (—COOH)
(5) A sulfonic acid group (—SO₃H)
(6) A phosphoric acid group (—OPO₃H₂)

In the items (1) to (6), Ar represents a bivalent aryl linking group which may have a substituent, and R represents a hydrogen atom or a hydrocarbon group which may have a substituent.

Examples of the monomer having a phenol group in the item (1) include acrylamide, methacrylamide, acrylic acid esters and methacrylic acid esters each of which has a phenol group, and hydroxystyrene.

Examples of the monomer having a sulfonamide group in the item (2) include compounds each having in the molecule thereof one or more sulfonamide groups having the above-mentioned structure and one or more unsaturated groups which can be polymerized with the sulfonamide group(s). Of these compounds, preferable are low molecular weight compounds each having in the molecule thereof an acryloyl, allyl or vinyloxy group, and a sulfonamide group. Examples thereof include compounds represented by any one of the following general formulae (i) to (v):

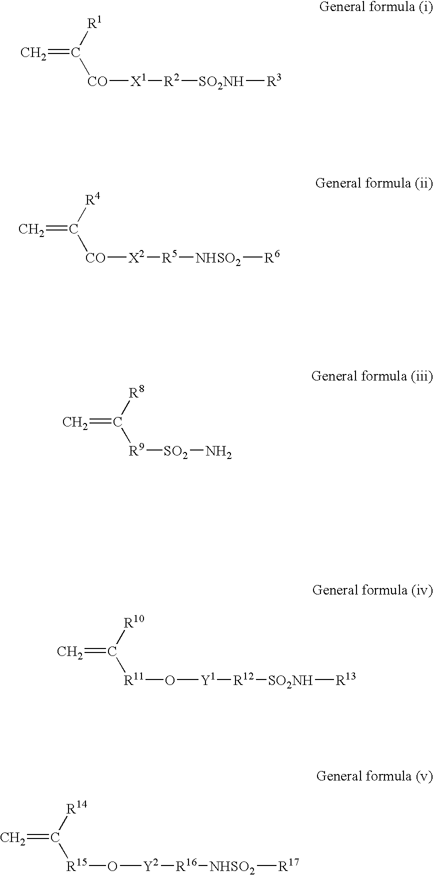

In the general formulae (i) to (v), X¹ and X² each independently represent —O—, or —NR⁷—; R¹ and R⁴ each independently represent a hydrogen atom, or —CH₃; R², R⁵, R⁹, R¹² and R¹⁶ each independently represent an alkylene, cycloalkylene, arylene or aralkylene group which may have a substituent and has 1 to 12 carbon atoms; R³, R⁷ and R¹³ each independently represent a hydrogen atom, or an alkyl, cycloalkyl, aryl or aralkyl group which may have a substituent and has 1 to 12 carbon atoms; R⁶ and R¹⁷ each independently represent an alkyl, cycloalkyl, aryl or aralkyl group which may have a substituent and has 1 to 12 carbon atoms; R⁸, R¹⁰ and R¹⁴ each independently represent a hydrogen atom or —CH₃; R¹¹ and R¹⁵ each independently represent a single bond, or an alkylene, cycloalkylene, arylene or aralkylene group which may have a substituent and has 1 to 12 carbon atoms; and Y¹ and Y² each independently represent a single bond or —CO—.

Of the compounds represented by the represented by the general formulae (i) to (v), in particular, the following can preferably be used in the invention: m-aminosulfonylphenyl methacrylate, N-(p-aminosulfonylphenyl)methacrylamide and N-(p-aminosulfonylphenyl)acrylamide.

Examples of the monomer having an active imide group in the item (3) include compounds each having in the molecule thereof one or more active imide groups represented by the above-mentioned structural formula and one or more unsaturated groups which can be polymerized with the active imide group(s). Of these compounds, preferable are compounds each having in the molecule thereof one or more active imide groups represented by the following structural formula and one or more unsaturated groups which can be polymerized with the active imide group(s):

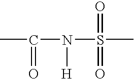

Specifically, N-(p-toluenesulfonyl)methacrylamide, N-(p-toluenesulfonyl)acrylamide and others can be preferably used.

Examples of the monomer having a carboxylic acid group in the item (4) include compounds each having in the molecule thereof one or more carboxylic acid groups and one or more unsaturated groups which can be polymerized with the carboxylic acid group(s).

Examples of the monomer having a sulfonic acid group in the item (5) include compounds each having in the molecule thereof one or more sulfonic acid groups and one or more unsaturated groups which can be polymerized with the sulfonic acid group(s).

Examples of the monomer having a phosphoric acid group in the item (6) include compounds each having in the molecule thereof one or more phosphoric acid group and one or more unsaturated groups which can be polymerized with the phophoric acid group(s).

Examples of the copolymerization component other than the polyfunctional monomer include monomers as described in the following items (7) to (17) besides the monomers in the items (1) to (6):
(7) Acrylic acid esters and methacrylic acid esters having an aliphatic hydroxyl group, such as 2-hydroxyethyl acrylate and 2-hydroxyethyl methacrylate.
(8) Acrylates, such as methyl acrylate, ethyl acrylate, propyl acrylate, amyl acrylate, benzyl acrylate, 2-chloroethyl acrylate, glycidyl acrylate, N-dimethylaminoethyl acrylate, polyethylene glycol monoacrylate, and polypropylene glycol monoacrylate.
(9) Methacrylates, such as methyl methacrylate, ethyl methacrylate, propyl methacrylate, amyl methacrylate, cyclohexyl methacrylate, benzyl methacrylate, 2-chloroethyl methacrylate, glycidyl methacrylate, N-dimethylaminoethyl methacrylate, polyethylene glycol monomethacrylate, and polypropylene glycol monomethacrylate.
(10) Acrylamides or methacrylamides, such as acrylamide, methacrylamide, N-methylolacrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacrylamide.
(11) Vinyl ethers, such as ethyl vinyl ether, 2-chloroethyl vinyl ether, hydroxyethyl vinyl ether, propyl vinyl ether, butyl vinyl ether, and phenyl vinyl ether.
(12) Vinyl esters, such as vinyl acetate, vinyl chloroacetate, vinyl butyrate, and vinyl benzoate.
(13) Styrenes, such as styrene, α-methylstyrene, methylstyrene, and chloromethylstyrene.
(14) Vinyl ketones, such as methyl vinyl ketone, ethyl vinyl ketone, propyl vinyl ketone, and phenyl vinyl ketone.
(15) Olefins, such as ethylene, propylene, isobutylene, butadiene, and isoprene.
(16) N-vinylpyrrolidone, N-vinylcarbazole, 4-vinylpyridine, acrylonitrile, methacrylonitrile, and so on.
(17) Unsaturated imides, such as maleimide, N-acryloylacrylamide, N-acetylmethacrylamide, N-propionylmethacrylamide, and N-(p-chlorobenzoyl)methacrylamide.

The specific polymer preferably comprises the monomer having a sulfonamide group in the item (2), the monomer having a carboxylic acid group in the item (4), the monomer having acrylate in the item (8), or the monomer having methacrylate in the item (9) out of the above-mentioned monomers. The specific polymer most preferably comprises the monomer having a carboxylic acid group in the item (4) in order to keep sufficient solubility in alkaline developer, development latitude and film strength.

The copolymerization components other than the polyfunctional monomer may be used alone or in combination of two or more thereof.

Regarding the copolymerization ratio between the polyfunctional monomer and a monomer of different type as a copolymerization component, i.e., the ratio of the polyfunctional monomer with respect to the total amount of the monomers, is preferably from 0.5 to 40%, more preferably from 1 to 30% by mole from the viewpoint of inhibition of gelation.

Regarding the specific polymer, the weight-average molecular weight thereof is preferably 5,000 or more and the number-average molecular weight thereof is preferably from 1,000 or more. The weight-average molecular weight in terms of polystyrene is more preferably from 10,000 to 5,000,000, even more preferably from 10,000 to 2,000,000.

The specific polymers may be used alone in combination of two or more thereof in the image recording material of the invention.

The content by percentage of the specific polymer in the image recording material of the invention can be appropriately selected in accordance with the use purpose of the image recording material, and is preferably from 3.0 to 70%, more preferably from 5.0 to 50% by mass of all solid contents in the image recording material.

When the specific polymer is added to the composition which constitutes the image recording material, the specific polymer may be used alone or together with a known solvent and known additive.

The specific polymer can be synthesized by a known radical polymerization method (such as a graft copolymerization, block copolymerization, random copolymerization, or living copolymerization method).

Of these specific polymers, specific examples of polymers which can be preferably used in the invention are illustrated below. However, the specific polymer in the invention is not limited to the specific examples. 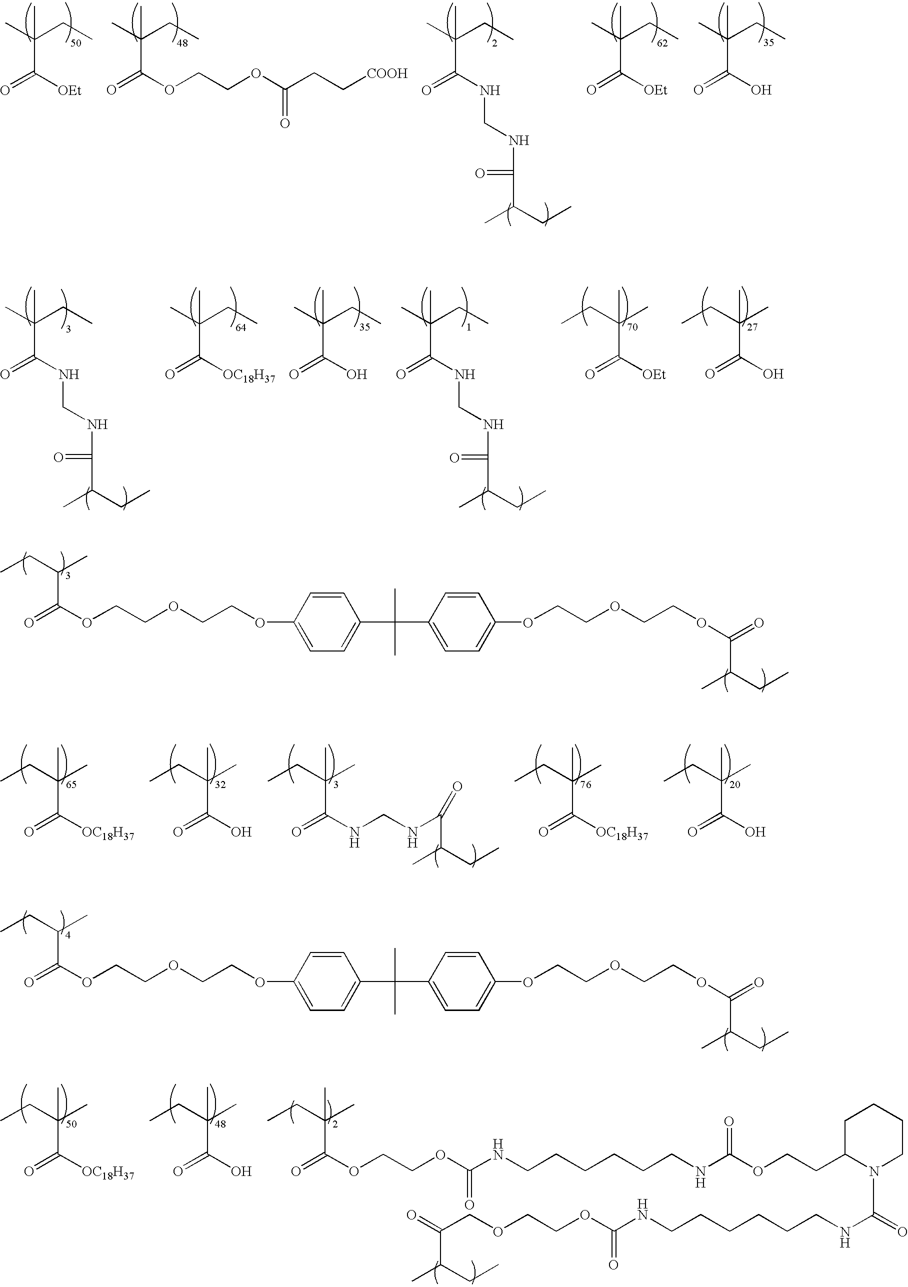 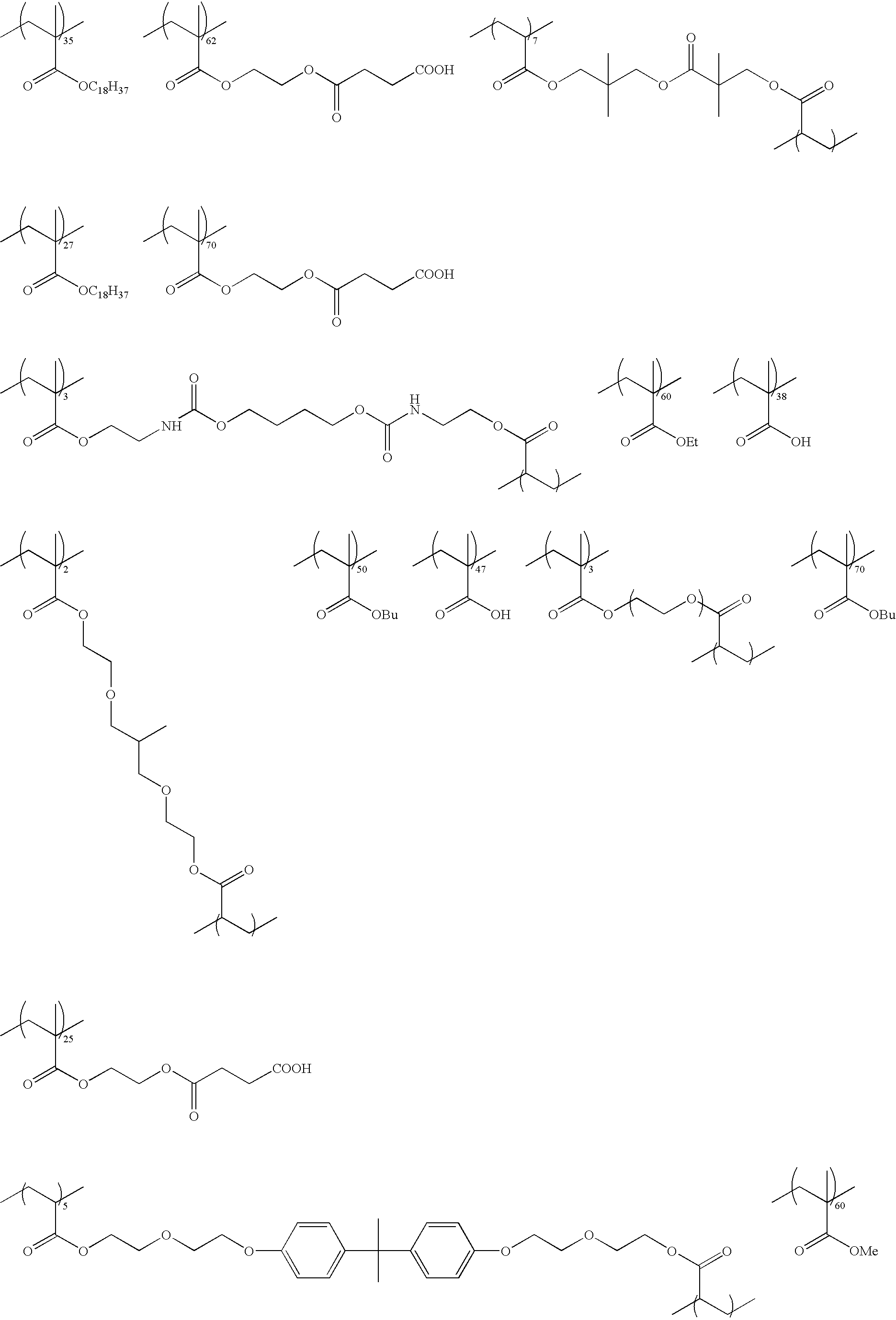 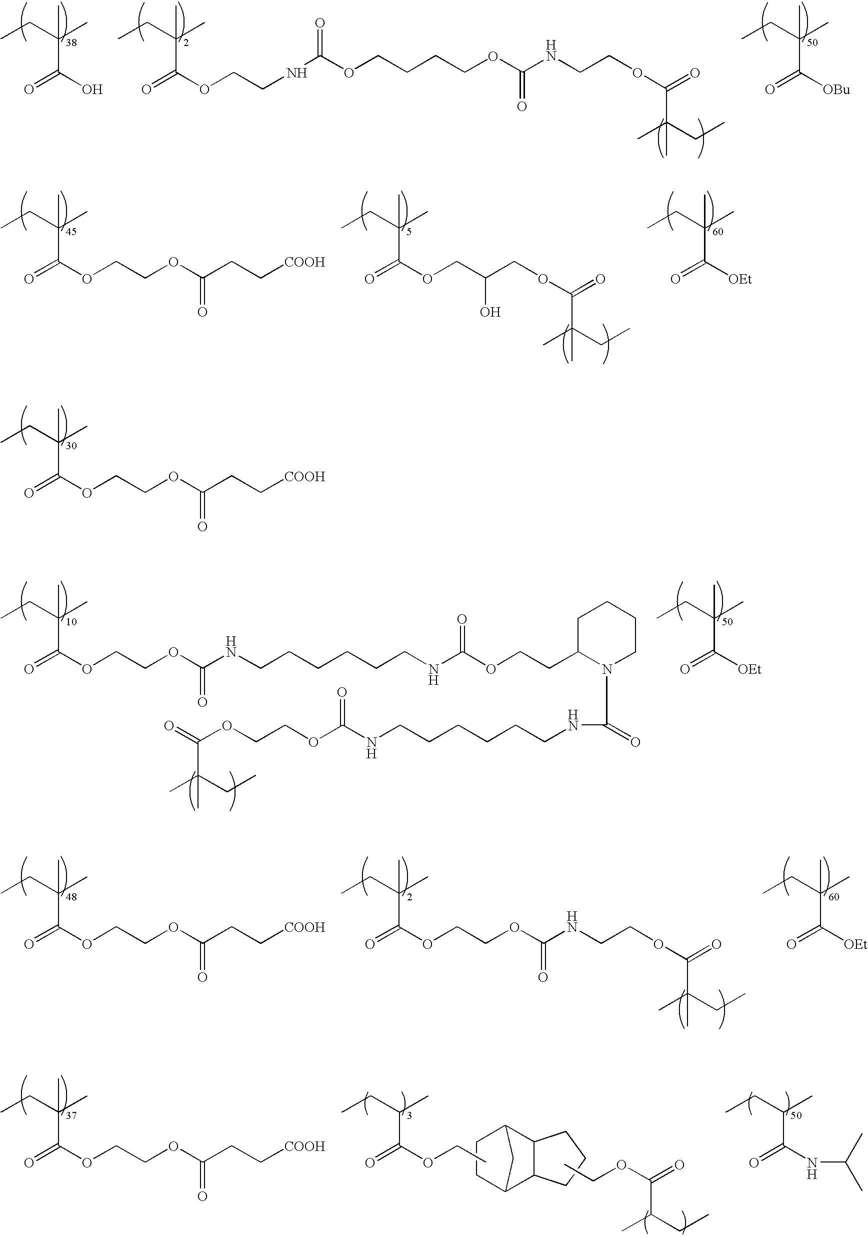 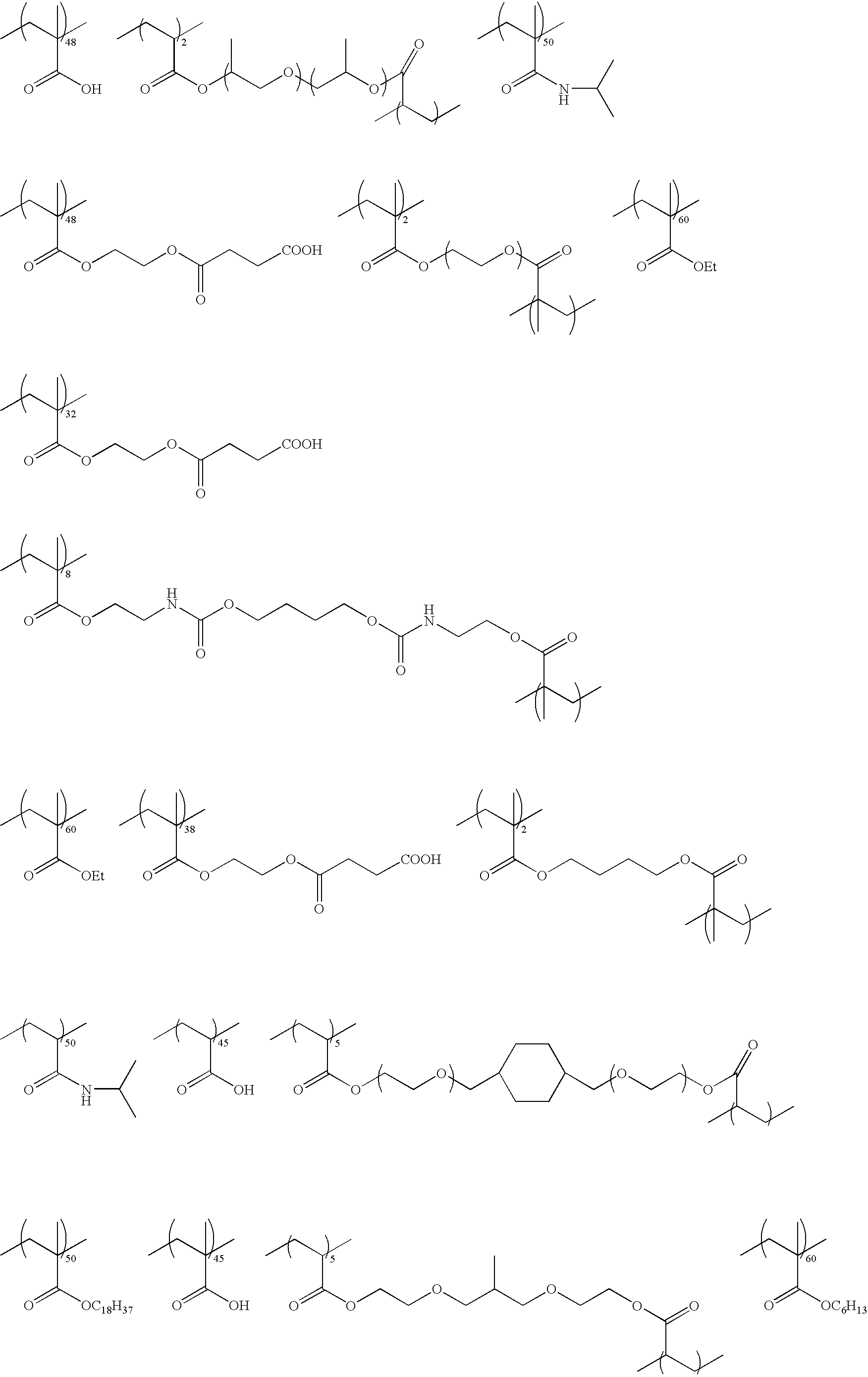 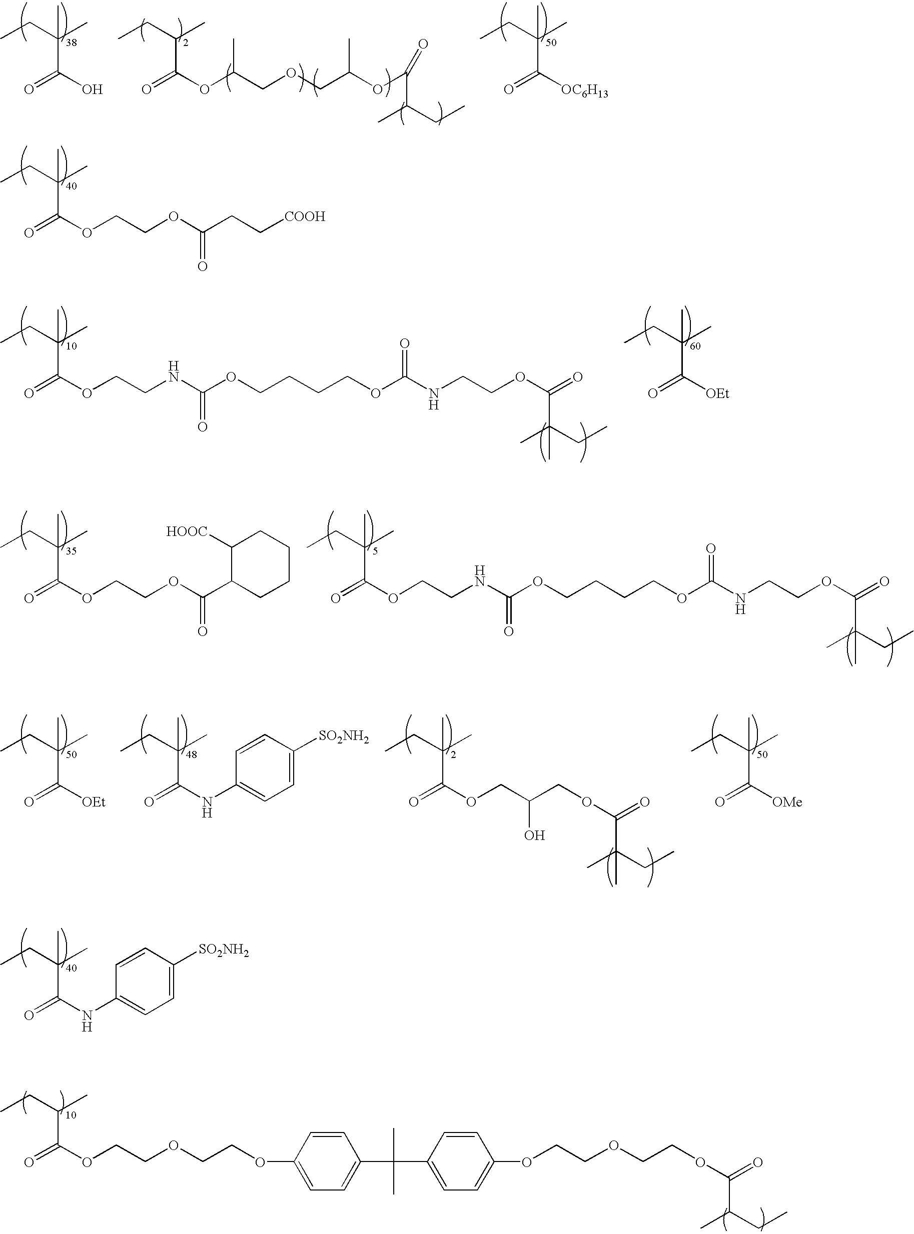 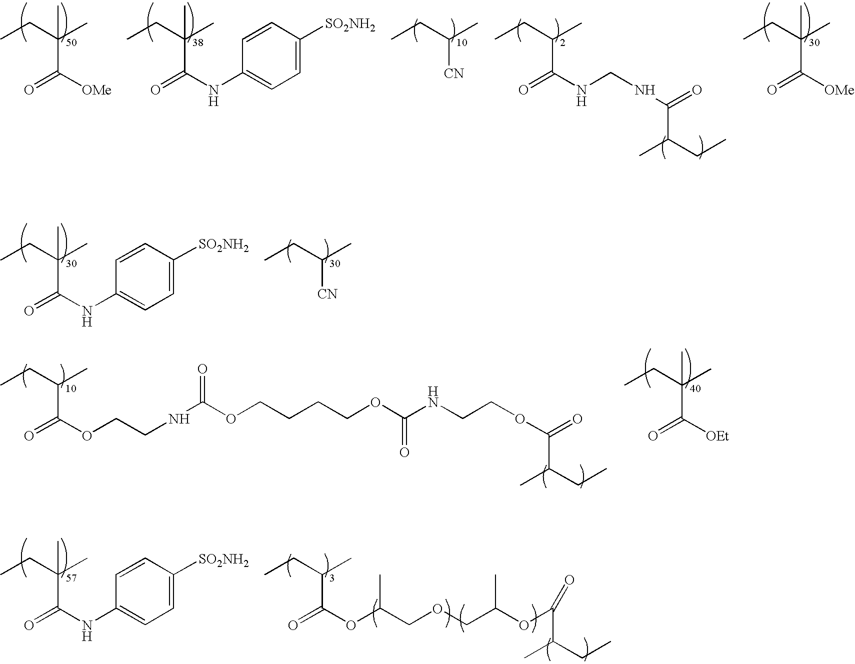
[Infrared Absorbent (B)]

The infrared absorbent used in the invention may be any infrared absorbent that absorbs light energy radiating rays to generate heat. The absorption wavelength of the infrared absorbent is not particularly limited. From the viewpoints of suitability to high-power lasers and being readily available, preferable examples thereof include infrared absorbing dyes and pigments having an absorption maximum in a wavelength range of 760 to 1200 nm.

The dyes may be commercially available ones and known ones described in publications such as “Dye Handbook” (edited by the Society of Synthesis Organic Chemistry, Japan, and published in 1970). Specific examples thereof include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squalirium dyes, pyrylium dyes, metal thiolate complexes, oxonol dyes, diimonium dyes, aminium dyes, and croconium dyes.

Preferable examples of the dye include cyanine dyes described in JP-A Nos. 58-125246, 59-84356, 59-202829, and 60-78787; methine dyes described in JP-A Nos. 58-173696, 58-181690, and 58-194595; naphthoquinone dyes described in JP-A Nos. 58-112793, 58-224793, 59-48187, 59-73996, 60-52940, and 60-63744; squalirium dyes described in JP-A No. 58-112792; and cyanine dyes described in GB Patent No. 434,875.

Other preferable examples of the dye include near infrared absorbing sensitizers described in U.S. Pat. No. 5,156,938; substituted arylbenzo(thio)pyrylium salts described in U.S. Pat. No. 3,881,924; trimethinethiapyrylium salts described in JP-A No. 57-142645 (U.S. Pat. No. 4,327,169); pyrylium type compounds described in JP-A Nos. 58-181051, 58-220143, 59-41363, 59-84248, 59-84249, 59-146063, and 59-146061; cyanine dyes described in JP-A No. 59-216146; pentamethinethiopyrylium salts described in U.S. Pat. No. 4,283,475; and pyrylium compounds described in Japanese Patent Application Publication (JP-B) Nos. 5-13514 and 5-19702.

Additional preferable examples of the dye include near infrared absorbing dyes represented by formulae (I) and (II) as described in U.S. Pat. No. 4,756,993.

Among these dyes, particularly preferable are cyanine dyes, phthalocyanine dyes, oxonol dyes, squalirium dyes, pyrylium salts, thiopyrylium dyes, and nickel thiolate complexes. Dyes represented by the following general formulae (a) to (e) are also preferable since such dyes are excellent in terms of photothermal conversion efficiency. The cyanine dyes represented by the following general formula (a) are most preferable for the following reason: when the dyes are used in the photosensitive composition of the invention, the dyes manifest a high degree of interaction with the alkali-soluble resin, and the dyes are also excellent in terms of stability and economy.

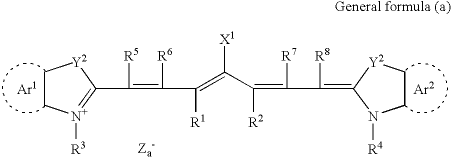

In general formula (a), X¹ represents a hydrogen atom, a halogen atom, —NPh₂, X²—L¹ (wherein X² represents an oxygen atom or a sulfur atom, L¹ represents a hydrocarbon group having 1 to 12 carbon atoms, an aromatic cyclic group having a heteroatom, or a hydrocarbon group containing a heteroatom and having 1 to 12 carbon atoms, and the heteroatom referred to herein is N, S, O, a halogen atom, or Se), or a group represented by the following: 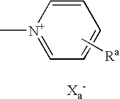
wherein Xa⁻ has the same definition as Za⁻, which will be described at a later time, and R^{a} represents a substituent selected from a hydrogen atom, an alkyl group, an aryl group, a substituted or unsubstituted amino group, or a halogen atom;

R¹ and R² each independently represents a hydrocarbon group having 1 to 12 carbon atoms, and from the viewpoint of the storage stability of the photosensitive composition of the invention when it is used in a coating solution for forming a recording layer of a planographic printing plate precursor, it is preferable that R¹ and R² each independently represents a hydrocarbon group having 2 or more carbon atoms, and more preferably R¹ and R² are bonded to each other to form a 5-membered or 6-membered ring.

Ar¹ and Ar², which may be the same or different, each represent an aromatic hydrocarbon group which may have a substituent. Preferable examples of the aromatic hydrocarbon group include benzene and naphthalene rings. Preferable examples of the substituent include hydrocarbon groups having 12 or less carbon atoms, halogen atoms, and alkoxy groups having 12 or less carbon atoms.

Y¹ and Y², which may be the same or different, each represents a sulfur atom, or a dialkylmethylene group having 12 or less carbon atoms.

R³ and R⁴, which may be the same or different, each represents a hydrocarbon group which has 20 or less carbon atoms and may have a substituent. Preferable examples of the substituent include alkoxy groups having 12 or less carbon atoms, a carboxyl group, and a sulfo group. R⁵, R⁶, R⁷ and R⁸, which may be the same or different, each represents a hydrogen atom, or a hydrocarbon group having 12 or less carbon atoms, and since the raw materials thereof can easily be obtained, each preferably represents a hydrogen atom.

Za⁻ represents a counter anion. However, in a case where the cyanine dye represented by general formula (a) has an anionic substituent in the structure thereof and there is accordingly no need to neutralize electric charges in the dye, Za⁻ is not required. From the viewpoint of the storage stability of the recording layer coating solution, Za⁻ is preferably an ion of a halogen, perchlorate, tetrafluroborate, hexafluorophosphate, carboxylate or sulfonate. From the viewpoints of compatibility of the dye with the alkali-soluble resin and solubility in the coating solution, Za⁻ is preferably a halogen ion, or an organic acid ion such as a carboxylic acid ion or sulfonic acid ion, more preferably a sulfonic acid ion, and even more preferably an arylsulfonic acid ion.

Specific examples of the cyanine dye represented by general formula (a), and which can be preferably used in the invention, include dyes in JP-A No. 2001-133969 (paragraphs [0017] to [0019]), JP-A No. 2002-40638 (paragraphs [0012] to [0038]), and JP-A No. 2002-23360 (paragraphs [0012] to [0023]), as well as dyes illustrated below.

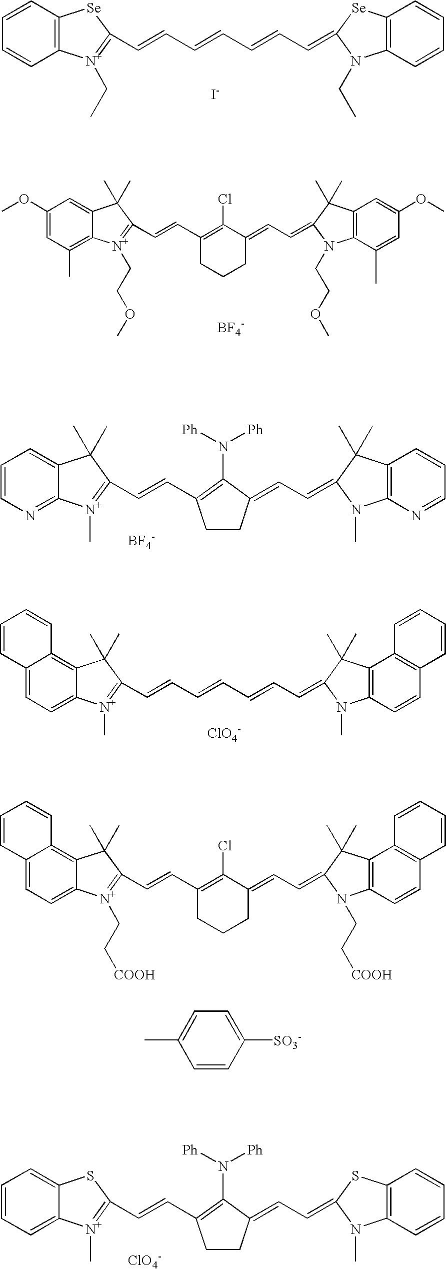

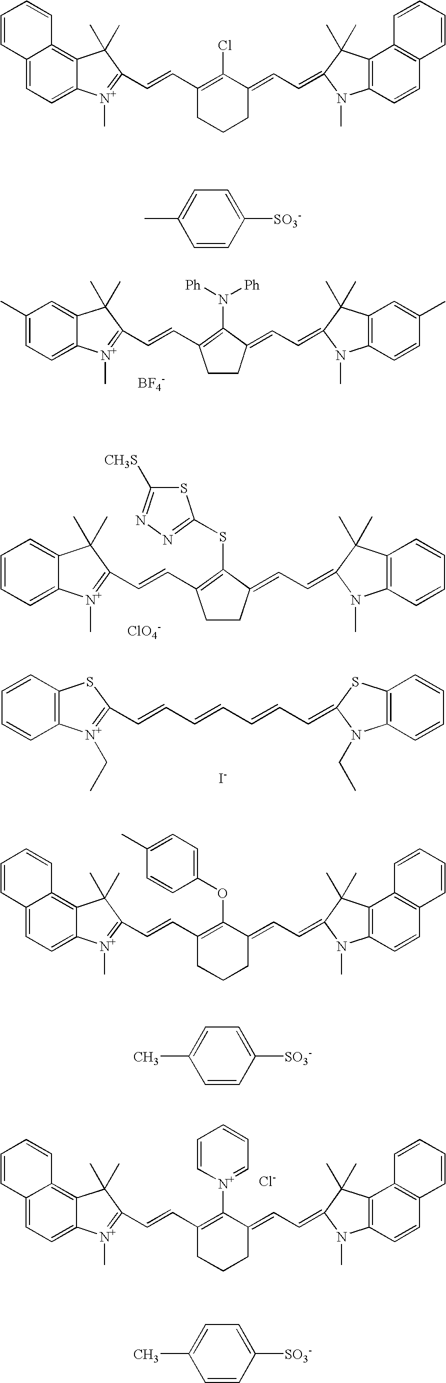

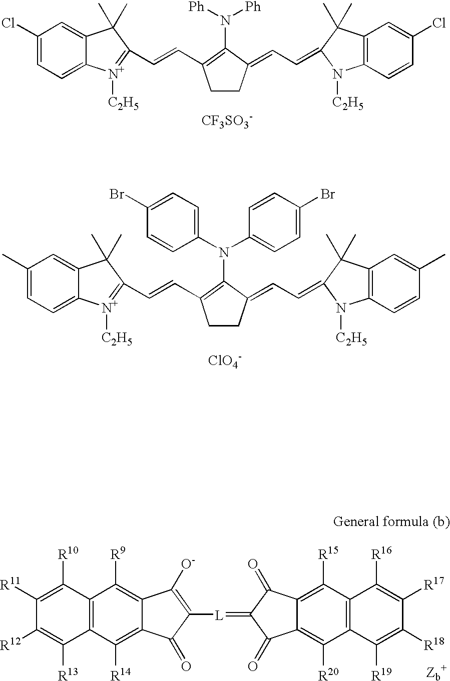

In general formula (b), L represents a methine chain having 7 or more conjugated carbon atoms, and the methine chain may have one or more substituent. The substituents may be bonded to each other to form a cyclic structure. Zb⁺ represents a counter cation. Preferable examples of the counter cation include ammonium, iodonium, sulfonium, phosphonium and pyridinium ions, and alkali metal cations (such as Ni⁺, K⁺ and Li⁺).

R⁹ to R¹⁴ and R¹⁵ to R²⁰ each independently represents a substituent selected from hydrogen atom, halogen atom, and cyano, alkyl, aryl, alkenyl, alkynyl, carbonyl, thio, sulfonyl, sulfinyl, oxy and amino groups; or a substituent obtained by combining two or three from among these substituents. Two or three out of R⁹ to R¹⁴ and R¹⁵ to R²⁰ may be bonded to each other to form a cyclic structure.

A dye wherein L in general formula (b) represents a methine chain having 7 conjugated carbon atoms, and each of R⁹ to R¹⁴ and R¹⁵ to R²⁰ represents a hydrogen atom, is preferable since such a dye can be easily obtained and exhibits advantageous effects.

Specific examples of the dye represented by general formula (b), and which can be preferably used in the invention, are illustrated below.

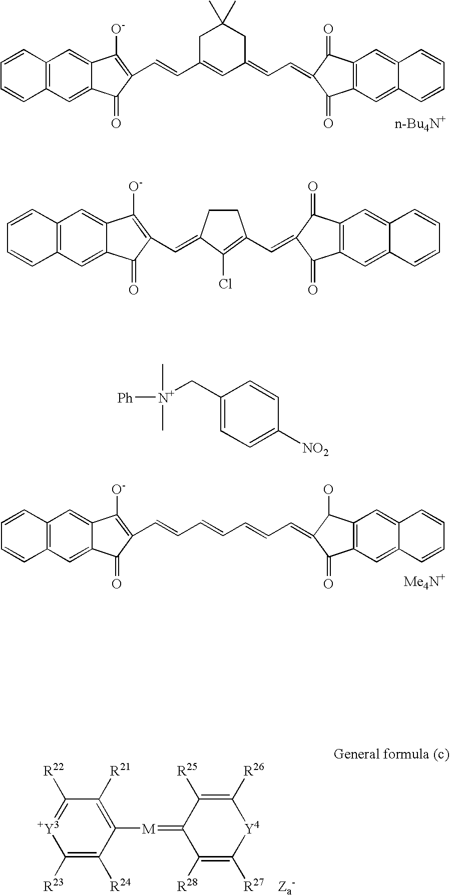

In general formula (c), Y³ and Y⁴ each independently represent an oxygen, sulfur, selenium or tellurium atom; M represents a methine chain having 5 or more conjugated carbon atoms; R²¹ to R²⁴ and R²⁵ to R²⁸, which may be the same or different, each represents a hydrogen or halogen atom, or a cyano, alkyl, aryl, alkenyl, alkynyl, carbonyl, thio, sulfonyl, sulfinyl, oxy or amino group; and Za⁻ represents a counter anion, and has the same meaning as Za⁻ in general formula (a).

Specific examples of the dye which is represented by general formula (c) and which can be preferably used in the invention, are illustrated below.

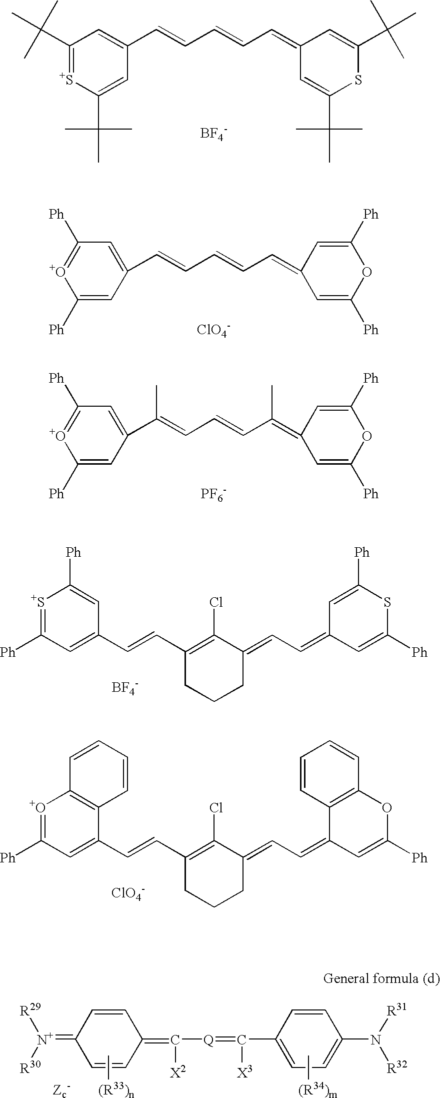

In general formula (d), R²⁹ to R³¹ each independently represents a hydrogen atom, an alkyl group or an aryl group; R³³ and R³⁴ each independently represents an alkyl group, a substituted oxy group, or a halogen atom; n and m each independently represents an integer of 0 to 4; and R²⁹ and R³⁰, or R³¹ and R³² may be bonded to each other to form a ring, or R²⁹ and/or R³⁰ may be bonded to R³³ to form a ring and R³¹ and/or R³² may be bonded to R³⁴ to form a ring. When plural R³³'s and R³⁴'s are present, R³³'s may be bonded to each other to form a ring, or R³⁴'s may be bonded to each other to form a ring.

X² and X³ each independently represents a hydrogen atom, an alkyl group or an aryl group, and at least one of X² and X³ represents a hydrogen atom or an alkyl group.

Q represents a trimethine group or a pentamethine group which may have a substituent, and may be combined with an bivalent linking group to form a cyclic structure. Zc⁻ represents a counter anion and has the same meanings as Za⁻ in general formula (a).

Specific examples of the dye represented by general formula (d) and which can be preferably used in the invention, are illustrated below.

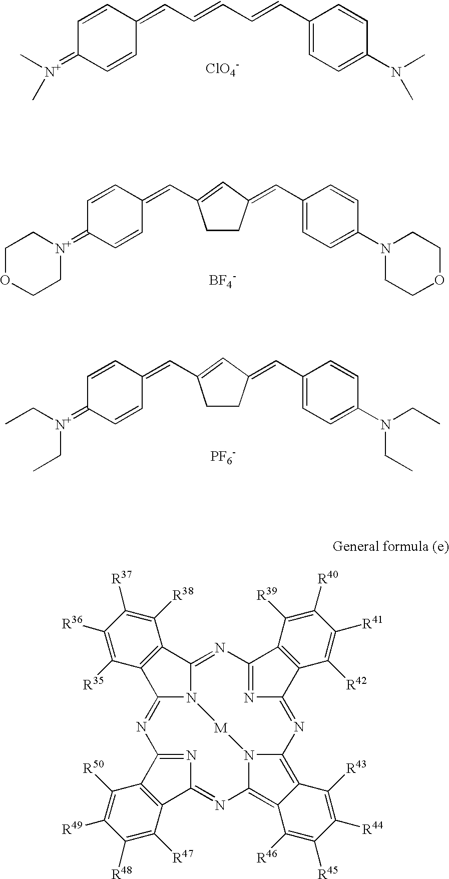

In general formula (e), R³⁵ to R⁵⁰ each independently represents a hydrogen or halogen atom, or a cyano, alkyl, aryl, alkenyl, alkynyl, hydroxyl, carbonyl, thio, sulfonyl, sulfinyl, oxy or amino group, or an onium salt structure, each of which may have a substituent; M represents two hydrogen atoms, a metal atom, a halo metal group, or an oxy metal group. Examples of the metal contained therein include atoms in IA, IIA, IIIB and IVB groups in the periodic table, transition metals in the first, second and third periods therein, and lanthanoid elements. Among these examples, preferable are copper, magnesium, iron, zinc, cobalt, aluminum, titanium, and vanadium.

Specific examples of the dye represented by general formula (e) and which can be preferably used in the invention, are illustrated below.

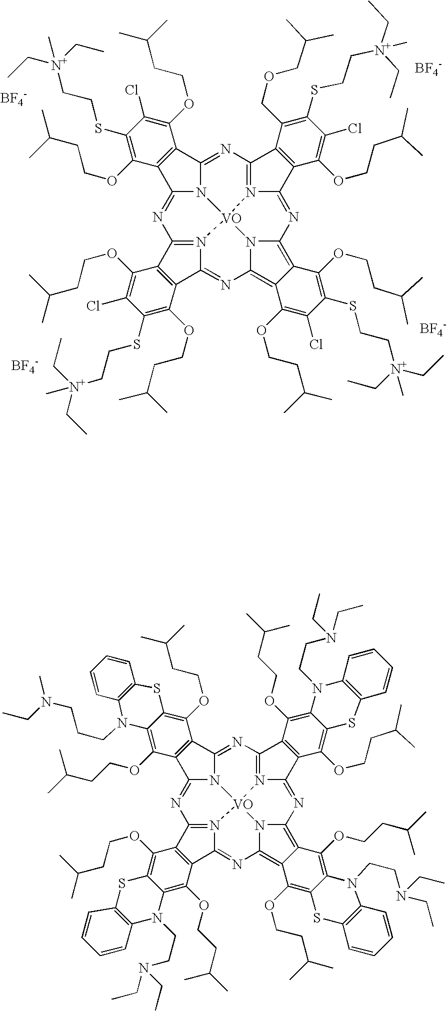

The pigment used as the infrared absorbent in the invention may be a commercially available pigment or a pigment described in publications such as Color Index (C.I.) Handbook, “Latest Pigment Handbook” (edited by Japan Pigment Technique Association, and published in 1977), “Latest Pigment Applied Technique” (by CMC Publishing Co., Ltd. in 1986), and “Printing Ink Technique” (by CMC Publishing Co., Ltd. in 1984).

Examples of the pigment include black pigments, yellow pigments, orange pigments, brown pigments, red pigments, purple pigments, blue pigments, green pigments, fluorescent pigments, metal powder pigments, and polymer-bonded dyes. Specifically, the following can be used: insoluble azo pigments, azo lake pigments, condensed azo pigments, chelate azo pigments, phthalocyanine pigments, anthraquinone pigments, perylene and perynone pigments, thioindigo pigments, quinacridone pigments, dioxazine pigments, isoindolinone pigments, quinophthalone pigments, dyeing lake pigments, azine pigments, nitroso pigments, nitro pigments, natural pigments, fluorescent pigments, inorganic pigments, and carbon black. Among these pigments, carbon black is preferable.

These pigments may be used with or without surface treatment. Examples of surface treatment include a method of coating the surface of the pigments with resin or wax; a method of adhering a surfactant onto the surface; and a method of bonding a reactive material (such as a silane coupling agent, an epoxy compound, or a polyisocyanate) to the pigment surface. The surface treatment methods are described in “Nature and Application of Metal Soap” (Saiwai Shobo), “Printing Ink Technique” (by CMC Publishing Co., Ltd. in 1984). And “Latest Pigment Applied Technique” (by CMC Publishing Co., Ltd. in 1986.

The particle size of the pigment is preferably from 0.01 to 10 μm, more preferably from 0.05 to 1 μm, and even more preferably from 0.1 to 1 μm. When a particle size is within the preferable range, a superior dispersion stability of the pigment in the photosensitive composition can be obtained, whereby, when the photosensitive composition of the invention is used for a recording layer of the photosensitive printing plate precursor, it is possible to form a homogeneous recording layer.

The method for dispersing the pigment may be a known dispersing technique used to produce ink or toner. Examples of a dispersing machine, which can be used, include an ultrasonic disperser, a sand mill, an attriter, a pearl mill, a super mill, a ball mill, an impeller, a disperser, a KD mill, a colloid mill, a dynatron, a three-roll mill, and a pressing kneader. Details are described in “Latest Pigment Applied Technique” (by CMC Publishing Co., Ltd. in 1986).

From the viewpoints of sensitivity, uniformity of the film to be formed and durability, the pigment or dye can be added to the photosensitive composition in a ratio of 0.01 to 50%, preferably 0.1 to 10%, and more preferably 0.5 to 10% (in the case of the dye) or 0.1 to 10% (in the case of pigment) by mass, relative to the total solid contents which constitute the photosensitive composition.

[Polymer Compound (C) Having a Phenolic Hydroxyl Group]

It is preferable that the image recording material of the invention comprises a polymer compound (C) having a phenolic hydroxyl group as an alkali-soluble resin together with the components (A) and (B).

This polymer compound, which has a phenolic hydroxyl group and is used as an alkali-soluble resin, may be any polymer compound that is water-insoluble and alkali-soluble and has in the molecule thereof a phenolic hydroxyl group. Specific examples thereof include Novolak resin, resol resin, polyvinylphenol resin, and acrylic resin having phenolic hydroxyl groups. Of these resins, Novolak resin, resol resin, and polyvinylphenol resin are preferable from viewpoints of the image-formability and thermosetting property thereof. Novolak resin, and polyvinylphenol resin are more preferable from the viewpoint of the stability thereof. Novolak resin is even more preferable since the starting materials thereof can easily be obtained and the resin can widely be used.

Novolak resin is a resin obtained by polycondensing at least one selected from phenols such as phenol, o-cresol, m-cresol, p-cresol, 2,5-xylenol, 3,5-xylenol, o-ethylphenyl, m-ethylphenol, p-ethylphenol, propylphenol, n-butylphenol, tert-butylphenol, 1-naphthol, 2-naphthol, pyrocatechol, resorcinol, hydroquinone, pyrogallol, 1,2,4-benzenetriol, phloroglucinol, 4,4′-biphenyldiol, and 2,2-bis(4′-hydroxyphenyl)propane with at least one selected from aldehydes (such as formaldehyde, acetoaldehyde, propionaldehyde, benzaldehyde, furfural, paraformaldehyde and paraaldehyde), and ketones (such as acetone, methyl ethyl ketone, and methyl isobutyl ketone) in the presence of an acidic catalyst.

In the invention, the phenol resin is preferably a polycondensate made from phenol, o-cresol, m-cresol, p-cresol, 2,5-xylenol, 3,5-xylenol or resorcinol as the phenol compound and formaldehyde, acetoaldehyde or propionaldehyde as the aldehyde or ketone, and is particularly preferably a polycondensate made from formaldehyde and mixed phenol compounds made of m-cresol/p-creson/2,5-xylenol/3,5-xylenol/resorcinol (mole ratio therebetween=40-100/0-50/0-20/0-20/0-20) or mixed phenol compounds made of phenol/m-cresol/p-cresol (mole ratio therebetween=0-100/0-70/0-60).

The image recording material of the invention preferably contains a dissolution suppressor, which will be detailed later. In this case, preferable is a polycondensate made from formaldehyde and mixed phenol compounds made of m-cresol/p-creson/2,5-xylenol/3,5-xylenol/resorcinol (mole ratio therebetween=70-100/0-30/0-20/0-20/0-20) or mixed phenol compounds made of phenol/m-cresol/p-cresol (mole ratio therebetween=10-100/0-60/0-40).

The weight-average molecular weight of the above-mentioned Novolak resin in terms of polystyrene on the basis on measurement by gel permeation chromatograph (hereinafter referred to merely as the “weight-average molecular weight”) is preferably from 500 to 20,000, more preferably from 1,000 to 15,000, even more preferably from 3,000 to 12,000. When the weight-average molecular weight is within this range, the film-formability of the image recording material is sufficient and the alkali-developability of exposed portions made of the material after IR irradiation, is excellent.

[Other Components]

Various additives may be added to the image recording material if necessary. In order to improve the capability of suppressing the dissolution of image portions made of the composition into developer, it is particularly preferable to add a substance which is thermally decomposable and lowers the solubility of the alkali-soluble resin substantially when not dissolved (i.e., a decomposable dissolution suppressor), such as an onium salt, o-quinonediazide compound or alkyl sulfonate. Preferable examples of the decomposable dissolution suppressor include onium salts such as diazonium, iodonium, sulfonium, and ammonium salts; and o-quinonediazide compounds. The diazonium, iodonium, and sulfonium salts are more preferable.

Preferable examples of the onium salt used in the invention include diazonium salts described in S. I. Schlesinger, Photogr. Sci. Eng., 18, 387 (1974), T. S. Bal et al., Polymer, 21, 423 (1980), and JP-A No. 5-158230; ammonium salts described in U.S. Pat. Nos. 4,069,055 and 4,069,056, and JP-A No.3-140140; phosphonium salts described in D. C. Necker et al., Macromolecules, 17, 2468 (1984), C. S. Wen et al., Teh, Proc. Conf. Rad. Curing ASIA, p478 Tokyo, October (1988), and U.S. Pat. Nos. 4,069,055 and 4,069,056; iodonium salts described in J. V. Crivello et al., Macromolecules, 10 (6), 1307 (1977), Chem. & Eng. News, November 28, p31 (1988), EP No. 104,143, U.S. Pat. Nos. 5,041,358 and 4,491,628, and JP-A Nos. 2-150848 and 2-296514; sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromolecules, 14 (5), 1141 (1981), J. V. Crivello et al., J. Polymer Sci., Polymer Chem. Ed., 17, 2877 (1979), EP Nos. 370,693, 233,567, 297,443 and 297,442, U.S. Pat. Nos. 4,933,377, 3,902,114, 5,041,358, 4,491,628, 4,760,013, 4,734,444 and 2,833,827, and DE Patent Nos. 2,904,626, 3,604,580 and 3,604,581; selenonium salts described in J. V. Crivello et al., Macromolecules, 10 (6), 1307 (1977), J. V. Crivello et al., J. Polymer Sci., Polymer Chem. Ed., 17, 1047 (1979); arsonium salts described in C. S. Wen et al., and The Proc. Conf. Rad. Curing ASIA, p478, Tokyo, October (1988).

Among such onium salts, diazonium salts are particularly preferable from the viewpoints of both their capacity of hindering dissolution, and their thermal decomposability. The diazonium salts represented by general formula (I) in the JP-A No. 5-158230 and the diazonium salts represented by general formula (1) in JP-A No. 11-143064 are more preferable, and diazonium salts represented by general formula (1) in the JP-A No. 11-143064, which have low absorption wavelength peaks within the visible ray range, are most preferable.

Examples of the counter ion of the onium salt include tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid, and p-toluenesulfonic acid. Among these examples, hexafluorophosphoric acid, and alkylaromatic sulfonic acids such as triisopropylnaphthalenesulfonic acid and 2,5-dimethylbezenesulfonic acid are particularly preferable.

The quinonediazide is preferably an o-quinonediazide compound. The o-quinonediazide compound used in the invention is a compound having at least one o-quinonediazide group and having an alkali-solubility increased by being thermally decomposed. The compound may be any one of compounds having various structures.

In other words, the o-quinonediazide compound assists the solubility of the photosensitive material both from the viewpoint of the effects of being thermally decomposed, and thereby losing the function of suppressing the dissolution of the binder, and the effect that the o-quinonediazide itself is changed into an alkali-soluble material.

Preferable examples of the o-quinonediazide compound used in the invention include compounds described in J. Coser, “Light-Sensitive Systems” (John Wiley & Sons. Inc.), pp. 339-352. Particularly preferable are sulfonic acid esters or sulfonamides of o-quinonediazide made to react with various aromatic polyhydroxy compounds or with aromatic amino compounds.

Further preferable examples include an ester made from benzoquinone-(1,2)-diazidesulfonic acid chloride or naphthoquinone-(1,2)-diazide-5-sulfonic acid chloride and pyrogallol-acetone resin, as described in JP-B No. 43-28403; and an ester made from benzoquinone-(1,2)-diazidesulfonic acid chloride or naphthoquinone-(1,2)-diazide-5-sulfonic acid chloride and phenol-formaldehyde resin.

Additional preferable examples include an ester made from naphthoquinone-(1,2)-diazide-4-sulfonic acid chloride and phenol-formaldehyde resin or cresol-formaldehyde resin; and an ester made from naphthoquinone-(1,2)-diazide-4-sulfonic acid chloride and pyrogallol-acetone resin.

Other useful o-quinonediazide compounds are reported in unexamined or examined patent documents, examples of which include JP-A Nos. 47-5303, 48-63802, 48-63803, 48-96575, 49-38701 and 48-13354, JP-B No. 41-11222, 45-9610 and 49-17481, U.S. Pat. Nos. 2,797,213, 3,454,400, 3,544,323, 3,573,917, 3,674,495 and 3,785,825, GB Patent Nos. 1,227,602, 1,251,345, 1,267,005, 1,329,888 and 1,330,932, and DE Patent No. 854,890.

When the photosensitive composition of the invention is used as a recording layer of a planographic printing plate precursor, the amount of onium salt and/or o-quinonediazide compound added as the decomposable dissolution suppresser(s) is preferably from 0.1 to 10%, more preferably from 0.1 to 5%, and even more preferably from 0.2 to 2% by relative to the total solid contents of the recording layer. The onium salts and the o-quinonediazide compounds may be used either independently or in the form of mixtures of two or more thereof.

The amount of additives other than the o-quinonediazide compound added is preferably from 0 to 5%, more preferably from 0 to 2%, and even more preferably from 0.1 to 1.5% by mass. The additives and the binder used in the invention are preferably incorporated into the same layer.

A dissolution suppresser having no decomposability may be used in combination. Preferable examples thereof include sulfonic acid esters, phosphoric acid esters, aromatic carboxylic acid esters, aromatic disulfones, carboxylic acid anhydrides, aromatic ketones, aromatic aldehydes, aromatic amines, and aromatic ethers, details of which are described in JP-A No. 10-268512; acidic color-developable dyes which have a lactone skeleton, an N,N-diarylamide skeleton or a diarylmethylimino skeleton and also function as a coloring agent, details of which are described in JP-A No. 11-190903; and nonionic surfactants described, details of which are described in JP-A No. 2000-105454.

In order to strengthen discrimination of images to be obtained (discrimination of hydrophobicity and hydrophilicity), or to improve the resistance of the surface against scratches, the following also may be used: a polymer containing, as a polymerization component, a (meth)acrylic monomer having in the 2 or 3 perfluoroalkyl groups having 3 to 20 carbon atoms. When the photosensitive composition of the invention is used as a recording layer of a planographic printing plate precursor, in relation to the total solid contents of the recording layer, the amount of this compound added is preferably from 0.1 to 10%, and more preferably from 0.5 to 5% by mass.

In order to provide the photosensitive composition of the invention with resistance against scaratches, a compound for lowering the static friction coefficient of the surface may be added to the composition. Specific examples thereof include long-chain alkyl carboxylic acid esters as described in U.S. Pat. No. 6,117,913. When the photosensitive composition of the invention is used as a recording layer of a planographic printing plate precursor, in relation to the total solid contents of the recording layer, the amount of such a compound added is preferably from 0.1 to 10%, and more preferably from 0.5 to 5% by mass.

The photosensitive composition of the invention may, whenever necessary, contain a compound having an acidic group of low-molecular weight. Examples of such an acidic group include sulfonic acid, carboxylic acid and phosphoric acid groups. Compounds having a sulfonic acid group are particularly preferable. Specific examples include aromatic sulfonic acids and aliphatic sulfonic acids such as p-toluenesulfonic acid and naphthalenesulfonic acid.

In order to enhance sensitivity, the photosensitive composition may also contain a cyclic acid anhydride, a phenolic compound, or an organic acid.

Examples of cyclic acid anhydride include phthalic anhydride, tetrahydrophthalic anhydride, hexahydrophthalic anhydride, 3,6-endooxy-Δ4-tetrahydrophthalic anhydride, tetrachlorophthalic anhydride, maleic anhydride, chloromaleic anhydride, α-phenylmaleic anhydride, succinic anhydride, and pyromellitic anhydride which are described in U.S. Pat. No. 4,115,128.

Examples of phenolic compound include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane.

Examples of the organic acid include sulfonic acids, sulfonic acids, alkylsulfuric acids, phosphonic acids, phosphates, and carboxylic acids, which are described in JP-A No. 60-88942 or 2-96755. Specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

When the cyclic acid anhydride, the phenol or the organic acid is added to a recording layer of a planographic printing plate precursor, the ratio thereof in the recording layer is preferably from 0.05 to 20%, more preferably from 0.1 to 15%, and even more preferably from 0.1 to 10% by mass.

When the photosensitive composition according to the invention is used in a recording layer coating solution for a planographic printing plate precursor, in order to enhance stability in processes which affect conditions of developing, the following can be added: nonionic surfactants as described in JP-A Nos. 62-251740 and 3-208514; amphoteric surfactants as described in JP-A Nos. 59-121044 and 4-13149; siloxane compounds as described in EP No. 950517; and copolymers made from a fluorine-containing monomer as described in JP-A No. 11-288093.

Specific examples of nonionic surfactants include sorbitan tristearate, sorbitan monopalmitate, sorbitan trioleate, monoglyceride stearate, and polyoxyethylene nonyl phenyl ether. Specific examples of amphoteric surfactants include alkyldi(aminoethyl)glycine, alkylpolyaminoethylglycine hydrochloride, 2-alkyl-N-carboxyethyl-N-hydroxyethylimidazolinium betaine and N-tetradecyl-N,N′-betaine type surfactants (trade name: “Amolgen K”, manufactured by Dai-ichi Kogyo Seiyaku Co., Ltd.).

The siloxane compounds are preferably block copolymers made from dimethylsiloxane and polyalkylene oxide. Specific examples thereof include polyalkylene oxide modified silicones (trade names: DBE-224, DBE-621, DBE-712, DBE-732, and DBE-534, manufactured by Chisso Corporation; trade name: Tego Glide 100, manufactured by Tego Co., Ltd.).

The content of the nonionic surfactant and/or the amphoteric surfactant in the photosensitive composition is preferably from 0.05 to 15% by mass, and more preferably from 0.1 to 5% by mass.

To the photosensitive composition of the invention may be added a printing-out agent for obtaining a visible image immediately after the photosensitive composition of the invention has been heated by exposure to light, or a dye or pigment as an image coloring agent.

A typical example of a printing-out agent is a combination of a compound which is heated by exposure to light, thereby emitting an acid (an optically acid-generating agent), and an organic dye which can form salts (salt formable organic dye).

Specific examples thereof include combinations of an o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in each of JP-A Nos. 53-36223, 54-74728, 60-3626, 61-143748, 61-151644 and 63-58440.

The trihalomethyl compound is classified into an oxazol compound or a triazine compound. Both of the compounds provide excellent in stability over the passage of time and produce a vivid printed-out image.

As the image coloring agent, a dye different from the above-mentioned salt-formable organic dye may be used. Preferable examples of such a dye, and of the salt-formable organic dye, include oil-soluble dyes and basic dyes.

Specific examples thereof include Oil yellow #101, Oil Yellow #103, Oil Pink #312, Oil Green BG, Oil Blue BOS, Oil Blue #603, Oil Black BY, Oil Black BS, and Oil Black T-505 (each of which is manufactured by Orient Chemical Industries Ltd.); Victoria Pure Blue, Crystal Violet (CI42555), Methyl Violet (CI42535), Ethyl Violet, Rhodamine B (CI145170B), Malachite Green (CI42000), and Methylene Blue (CI52015).

Dyes described in JP-A No.62-293247 are particularly preferable. These dyes may be added to the photosensitive composition at a ratio of 0.01 to 10% by mass, and preferably 0.1 to 3% by mass, relative to the total solid contents therein.

Whenever necessary, a plasticizer may be added to the photosensitive composition of the invention to give flexibility to a coating film made from the composition. Examples of the plasticizer include oligomers and polymers of butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl olete, and acrylic acid and methacrylic acid.

In addition to the above, the following may be appropriately added to the composition, depending on the objective: an epoxy compound; a vinyl ether; a phenol compound having a hydroxymethyl group and a phenol compound having an alkoxymethyl group, described in JP-A No. 8-276558; and a cross-linkable compound having an effect of suppressing dissolution in an alkali, described in JP-A No. 11-160860, and which was previously proposed by the present inventors.

Because the photosensitive composition of the invention obtained as described above is excellent in terms of film-formability and strength of the coating film to be formed, and can give a high alkali-solubility to exposed portions obtained from the composition when exposure is effected to the exposed portion by infrared rays, the composition can be used suitably for a recording layer of a infrared-ray-applicable positive type planographic printing plate precursor.

[Application of the Composition to a Planographic Printing Plate Precursor]

In a case where the photosensitive composition of the invention is applied to a recording layer of a planographic printing plate precursor, the photosensitive composition is dissolved in a solvent and the solution can be applied onto a suitable support to form the recording layer. A protective layer, a resin intermediate layer, a back coating layer and other layers, which will all be described later, may be formed depending on the objective.

Examples of the solvent in this case include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetoamide, N,N-dimethylformamide, tetramethylurea, N-methylpyrrolidone, dimethylsulfoxide, sulfolane, γ-butyrolactone, and toluene. However, the solvent is not limited thereto. Moreover, these solvents may be used alone, or in a mixture form.

The density of the components of the solvent mentioned above (the total of solid contents containing the additives) is preferably from 1 to 50% by mass.

The amount of the solid contents applied onto the support material after the coating solution is applied and dried, which is varied in the accordance with the use purpose of the image recording material, is generally from 0.5 to 5.0 g/m² from the viewpoint of obtaining desired properties of the film on the support.

As the method for applying the coating solution, various methods may be used, examples of which include bar coater coating, spin coating, spray coating, curtain coating, dip coating, air knife coating, blade coating and roll coating.

A surfactant can be incorporated into the coating solution for the recording layer wherein the image recording material of the invention is used, in order to improve the applicable property of the coating solution. An example of the surfactant is a fluorine-containing surfactant described in JP-A No. 62-170950. The amount of the surfactant added is preferably from 0.01 to 1% by mass, more preferably from 0.05 to 0.5% by mass of all solid contents in the recording layer.

[Resin Intermediate Layer]

If necessary, a resin intermediate layer may be formed between the support and the recording layer in the planographic printing plate precursor to which the invention is applied.

This resin intermediate layer, which is made of a polymer, functions as a heat insulating layer. Thus, heat generated by exposing the precursor to an infrared laser does not diffuse into the support and is effectively used. Consequently, the planographic printing plate precursor has an advantage that the recording layer thereof can have a high sensitivity. When this resin intermediate layer is formed, the recording layer is positioned to have a surface to be exposed to light or positioned near the surface; therefore, the sensitivity thereof to the infrared laser is satisfactorily kept.

In the unexposed portions of the recording layer, the recording layer itself, which alkaline developer does not penetrate, functions as a protective layer for the resin intermediate layer. Accordingly, the development stability of the printing plate precursor is made good and further images superior in discrimination are formed. Moreover, the stability of the images would be maintained in a long period of time.

The resin intermediate layer is preferably formed as a layer made mainly of alkali-soluble resin, so as to be very good in solubility in the developer. Therefore, for example, even when a developer having lowered activity is used, the resin intermediate layer formed adjacent to the support is swiftly removed when the components of the recording layer are exposed to light and the dissolution-suppressing capability thereof is cancelled by exposure, which results in rapid removal of the exposed portions without leaving any portion of the recording layer. This fact would contribute to an improvement in the developability of the printing plate precursor. For these reasons, the resin intermediate layer would be useful.

[Support]

The support used in the planographic printing plate precursor is a plate having dimensional stability. A plate satisfying required physical properties such as strength and flexibility can be used without any restriction. Examples thereof include paper, plastic (such as polyethylene, polypropylene or polystyrene)-laminated papers, metal plates (such as aluminum, zinc and copper plates), plastic films (such as cellulose biacetate, cellulose triacetate, cellulose propionate, cellulose lactate, cellulose acetate lactate, cellulose nitrate, polyethylene terephthalate, polyethylene, polystyrene, polypropylene, polycarbonate, and polyvinyl acetate films), and papers or plastic films on which, as described above, a metal is laminated or vapor-deposited.

The support is preferably a polyester film or an aluminum plate, and more preferably an aluminum plate, since an aluminum plate is superior in terms of dimensional stability and is also relatively inexpensive.

Preferable examples of the aluminum plate include a pure aluminum plate and alloy plates made of aluminum as a main component with a very small amount of other elements. A plastic film on which aluminum is laminated or vapor-deposited may also be used.

Examples of other elements contained in the aluminum alloys include silicon, iron, manganese, copper, magnesium, chromium, zinc, bismuth, nickel, and titanium. The content by percentage of different elements in the alloy is at most 10% by mass. A particularly preferable aluminum plate in the invention is a pure aluminum plate; however, since from the viewpoint of refining a completely pure aluminum cannot be easily produced, a very small amount of other elements may also be contained in the plate.

The aluminum plate used as the support is not specified in terms of the composition thereof. Thus, aluminum plates which are conventionally known can be appropriately used. The thickness of the aluminum plate used in the invention is from about 0.1 to 0.6 mm, preferably from 0.15 to 0.4 mm, and more preferably from 0.2 to 0.3 mm.

If necessary, prior to the surface-roughening treatment, the aluminum plate may optionally be subjected to degreasing treatment, in order to remove rolling oil or the like on the surface, with a surfactant, an organic solvent, an aqueous alkaline solution or the like.

The surface-roughening treatment of the aluminum surface can be performed by various methods such as a mechanical surface-roughening method, a method of dissolving and roughening the surface electrochemically, and a method of dissolving the surface selectively in a chemical manner.

Mechanical surface-roughening methods which can be used may be known methods, such as a ball polishing method, a brush polishing method, a blast polishing method or a buff polishing method. An electrochemical surface-roughening method may be a method of performing surface-roughening in an electrolyte of hydrochloric acid or nitric acid, by use of an alternating current or a direct current. As disclosed in JP-A No. 54-63902, a combination of the two kinds of methods may be used.

An aluminum plate whose surface is roughened as described above is if necessary subjected to alkali-etching treatment and neutralizing treatment. Thereafter, an anodizing treatment is optionally applied in order to improve the water holding capacity and wear resistance of the surface.

The electrolyte used in the anodizing treatment of the aluminum plate is any one selected from various electrolytes which can form a porous oxide film. Among which in general use are electrolytes of sulfuric acid, phosphoric acid, oxalic acid, chromic acid, or a mixed acid thereof. The concentration of the electrolyte may be appropriately decided depending on the kind of electrolyte selected.

Treatment conditions for anodization cannot be specified as a general rule since conditions vary depending on the electrolyte used; however, the following range of conditions are generally suitable: an electrolyte concentration of 1 to 80% by mass, a solution temperature of 5 to 70° C., a current density of 5 to 60 A/dm², a voltage of 1 to 100 V, and an electrolyzing time of 10 seconds to 5 minutes. If the amount of anodic oxide film is less than 1.0 g/m², printing resistance is inadequate or non-image portions of the planographic printing plate tend to become easily damaged and the so-called “blemish stains”, resulting from ink adhering to damaged portions at the time of printing, are easily generated.

After the anodizing treatment, the surface of the aluminum is if necessary subjected to treatment for obtaining hydrophilicity. This securance of hydrophilicity treatment may be an alkali metal silicate (for example, an aqueous sodium silicate solution) method, as disclosed in U.S. Pat. Nos. 2,714,066, 3,181,461, 3,280,734, and 3,902,734. In this method, the support is subjected to an immersing treatment or an electrolyzing treatment with an aqueous sodium silicate solution.

In addition, the following methods may also be used: a method of treating the support with potassium fluorozirconate, as disclosed in JP-B No. 36-22063, or with polyvinyl phosphonic acid, as disclosed in U.S. Pat. Nos. 3,276,868, 4,153,461, and 4,689,272.

The planographic printing plate precursor to which the invention is applied is a precursor wherein a positive type recording layer is formed on a support. If necessary, an undercoat layer may be formed therebetween.

As components of the undercoat layer, various organic compounds can be used. Examples thereof include carboxymethylcellulose, dextrin, gum arabic, phosphonic acids having an amino group, such as 2-aminoethylphosphonic acid, organic phosphonic acids which may have a substituent, such as phenyl phosphonic acid, naphthylphosphonic acid, alkylphosphonic acid, glycerophosphonic acid, methylenediphosphonic acid and ethylenediphosphonic acid, organic phosphoric acids which may have a substituent, such as phenylphosphoric acid, naphthylphosphoric acid, alkylphosphoric acid and glycerophosphoric acid, organic phosphinic acids which may have a substituent, such as phenylphosphinic acid, naphthylphosphinic acid, alkylphosphinic acid and glycerophosphinic acid, amino acids such as glycine and β-alanine, and hydrochlorides of amines having a hydroxyl group, such as a hydrochloride of triethanolamine. These organic compounds may be used alone or in the form of a mixture made up of two or more thereof.

This organic undercoat layer may be formed by methods which can be described as follows: a method of applying onto the aluminum plate a solution wherein the above-mentioned organic compound is dissolved in water, or an organic solvent such as methanol, ethanol or methyl ethyl ketone, or a mixed solvent thereof and then drying the resultant aluminum plate, or a method of immersing the aluminum plate into a solution wherein the above-mentioned organic compound is dissolved in water, or an organic solvent such as methanol, ethanol or methyl ethyl ketone, or a mixed solvent thereof so as to adsorb the compound, washing the aluminum plate with water or the like, and then drying the resultant aluminum plate.

In the former method, the solution of the organic compound having a concentration of 0.05 to 10% by mass may be applied in various ways. In the latter method, the concentration of the organic compound in the solution is from 0.01 to 20%, preferably from 0.05 to 5%, the temperature for the immersion is from 20 to 90° C., preferably from 25 to 50° C., and the time taken for immersion is from 0.1 second to 20 minutes, preferably from 2 seconds to 1 minute.

The pH of the solution used in the above-mentioned methods can be adjusted into a range of 1 to 12 with a basic material such as ammonia, triethylamine or potassium hydroxide, or an acidic material such as hydrochloric acid or phosphoric acid. Moreover, a yellow dye may be added to the solution, in order to improve the tone reproducibility of the recording layer.

The amount of organic undercoat layer applied is suitably from 2 to 200 mg/m², preferably from 5 to 100 mg/m². If the amount applied is less than 2 mg/m², adequate printing resistance cannot be obtained. Moreover, if the amount applied is more than 200 mg/m², in the same way, adequate printing resistance cannot be obtained.

The positive type planographic printing plate precursor produced as described above is normally imagewise exposed to light, and then subjected to developing treatment.

The light source used for the normally image-exposure is preferably a light source having an emission wavelength within a range from near infrared wavelengths to infrared ray wavelengths, and more preferably is a solid laser or a semiconductor laser.

As the developer and replenisher for the planographic printing plate precursor wherein the photosensitive composition of the invention is used as its recording layer, aqueous solutions of a conventional alkali agent can be used.

Examples of the alkali agent include inorganic alkali salts such as sodium silicate, potassium silicate, trisodium phosphate, tripotassium phosphate, triammonium phosphate, disodium hydrogenphosphate, dipotassium hydrogenphosphate, diammonium hydrogenphosphate, sodium carbonate, potassium carbonate, ammonium carbonate, sodium hydrogencarbonate, potassium hydrogencarbonate, ammonium hydrogen carbonate, sodium borate, potassium borate, ammonium borate, sodium hydroxide, ammonium hydroxide, potassium hydroxide and lithium hydroxide; and organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine. These alkali agents may be used alone or in combinations of two or more thereof.

Among these alkali agents, silicates such as sodium silicate and potassium silicate are particularly preferable for the developer. This is because the developing capacity of the developer can be controlled by adjusting the ratio between silicon oxide (SiO₂) and alkali metal oxide (M₂O), which are components of any one of the silicates, and by adjusting the concentrations thereof. For example, alkali metal silicates as described in JP-A No. 54-62004 or JP-B No. 57-7427 can be effectively used.

In a case where an automatic developing machine is used to perform development, an aqueous solution having a higher alkali intensity than that of the developer (or, replenisher) can be added to the developer. It is known that this makes it possible to treat a great number of photosensitive plates without recourse to replacing the developer in the developing tank over a long period of time. This replenishing manner is also preferably used in the invention.

If necessary, various surfactants or organic solvents can be incorporated into the developer and the replenisher in order to promote and suppress development capacity, disperse development scum, and enhance the ink-affinity of image portions of the printing plate.

Preferable examples of the surfactant include anionic, cationic, nonionic and amphoteric surfactants. If necessary, the following may be added to the developer and the replenisher: a reducing agent (such as hydroquinone, resorcin, a sodium or potassium salt of an inorganic acid such as sulfurous acid or hydrogen sulfite acid), an organic carboxylic acid, an antifoaming agent, and a water softener.

The printing plate developed with the developer and replenisher described above is subsequently subjected to treatments with washing water, a rinse solution containing a surfactant and other components, and a desensitizing solution containing gum arabic and a starch derivative. For after treatment following use of the photosensitive composition of the invention as a planographic printing plate precursor, various combinations of these treatments may be employed.

In recent years, automatic developing machines for printing plate precursors have been widely used in order to rationalize and standardize plate-making processes in the plate-making and printing industries. These automatic developing machines are generally made up of a developing section and a post-processing section, and include a device for carrying printing plate precursors, various treating solution tanks, and spray devices. These machines are machines for spraying respective treating solutions, which are pumped up, onto an exposed printing plate through spray nozzles, for development, while the printing plate is transported horizontally.

Recently, a method has also attracted attention in which a printing plate precursor is immersed in treating solution tanks filled with treating solutions and conveyed by means of in-liquid guide rolls. Such automatic processing can be performed while replenishers are being replenished into the respective treating solutions in accordance with the amounts to be treated, operating times, and other factors.

A so-called use-and-dispose processing manner can also be used, in which treatments are conducted with treating solutions which in practice have yet been used.

In cases where unnecessary image portions (for example, a film edge mark of an original picture film) are present on a planographic printing plate obtained by exposing imagewise to light a planographic printing plate precursor to which the invention is applied, developing the exposed precursor, and subjecting the developed precursor to water-washing and/or rinsing and/or desensitizing treatment(s), unnecessary image portions can be erased.

The erasing is preferably performed by applying an erasing solution to unnecessary image portions, leaving the printing plate as it is for a given time, and washing the plate with water, as described in, for example, JP-B No. 2-13293. This erasing may also be performed by a method of radiating active rays introduced through an optical fiber onto the unnecessary image portions, and then developing the plate, as described in JP-A No. 59-174842.

The planographic printing plate obtained as described above is, if desired, coated with a desensitizing gum, and subsequently the plate can be made available for a printing step. When it is desired to make a planographic printing plate have a higher degree of printing resistance, burning treatment is applied to the planographic printing plate.

In a case where the planographic printing plate is subjected to the burning treatment, it is preferable that before the burning treatment takes place the plate is treated with a surface-adjusting solution as described in JP-B No. 61-2518, or JP-A Nos. 55-28062, 62-31859 or 61-159655.

This method of treatment is, for example, a method of applying the surface-adjusting solution onto the planographic printing plate with a sponge or absorbent cotton infiltrated with the solution, a method of immersing the planographic printing plate in a vat filled with the surface-adjusting solution, or a method of applying the surface-adjusting solution to the planographic printing plate with an automatic coater. In a case where after application the amount of solution applied is made uniform with a squeegee or a squeegee roller, a better result can be obtained.

In general, the amount of surface-adjusting solution applied is suitably from 0.03 to 0.8 g/m² (dry mass). If necessary the planographic printing plate onto which the surface-adjusting solution is applied can be dried, and then the plate is heated to a high temperature by means of a burning processor (for example, a burning processor (BP-1300) sold by Fuji Photo Film Co., Ltd.) or the like. In this case the heating temperature and the heating time, which depend on the kind of components forming the image, are preferably from 180 to 300° C. and from 1 to 20 minutes, respectively. By means of this treatment, the recording layer related to the invention can manifest a superior burning printing resistance.

If necessary, a planographic printing plate subjected to burning treatment can be subjected to treatments which have been conventionally conducted, such as a water-washing treatment and gum coating. However, in a case where a surface-adjusting solution containing a water soluble polymer compound or the like is used, the so-called desensitizing treatment (for example, gum coating) can be omitted. The planographic printing plate obtained as a result of such treatments is applied to an offset printing machine or to some other printing machine, and is used for printing on a great number of sheets.

### EXAMPLES

The present invention will be described in detail by way of the following examples. However, the invention is not limited to the examples. In the examples, characteristics of planographic printing plate precursors wherein image recording materials of the invention are used for recording layers thereof have been evaluated. The results are used to evaluate the image recording materials of the invention.

### Synthesis Example 1

### Synthesis of Specific Polymer A

Into a 200-mL three-neck flask equipped with a condenser and a stirrer was charged 31.5 g of 1-methoxy-2-propanol, and then the system was heated to 80° C. Under a flow of nitrogen air, to the solution were dropwise added 14.6 g of ethyl methacrylate, 16.1 g of a monomer A (having a structure illustrated below), 0.308 g of methylenebisacrylamide, 0.461 g of a polymerization initiator (trade name: V-601, available from Wako Pure Chemical Industries, Ltd.) and 31.5 g of 1-methoxy-2-propanol for 2.5 hours. The components were allowed to be reacted with each other at 80° C. for 2 hours.

The reaction mixed solution was cooled to room temperature, and then the reaction solution was poured into 500 mL of water. The solution was subjected to decantation and then washed with methanol. The resultant liquid product was dried under reduced pressure to yield 29.5 g of a specific polymer A (having a structure illustrated below). Measurement based on gel permeation chromatography (GPC) using polystyrene as a standard substance demonstrated that the weight-average molecular weight of the polymer A was 110,000.

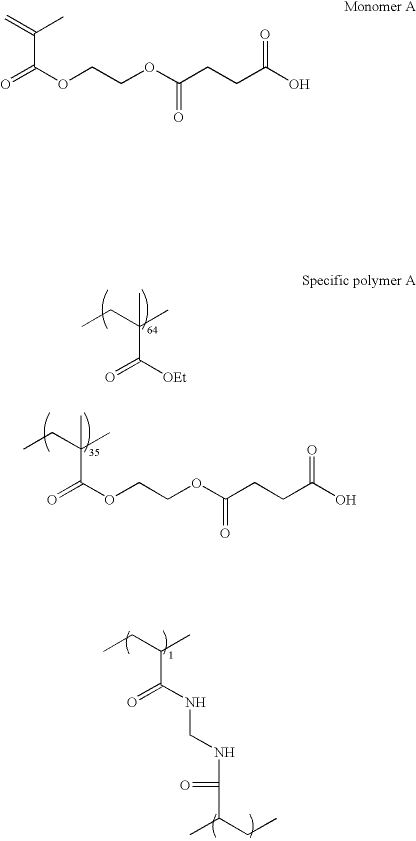

### Synthesis Example 2

### Synthesis of Specific Polymer B

Into a 200-mL three-neck flask equipped with a condenser and a stirrer was charged 31.7 g of 1-methoxy-2-propanol, and then the system was heated to 80° C. Under a flow of nitrogen air, to the solution were dropwise added 14.2 g of ethyl methacrylate, 16.1 g of the monomer A (having the structure illustrated above), 0.925 g of methylenebisacrylamide, 0.461 g of the polymerization initiator (trade name: V-601, available from Wako Pure Chemical Industries, Ltd.), 1.31 g of mercaptopropionic acid-2-ethylhexyl and 31.7 g of 1-methoxy-2-propanol for 2.5 hours. The components were allowed to be reacted with each other at 80° C. for 2 hours.

The reaction mixed solution was cooled to room temperature, and then the reaction solution was poured into 200 mL of water. The solution was subjected to decantation and then washed with methanol. The resultant liquid product was dried under reduced pressure to yield 30.1 g of a specific polymer B (having a structure illustrated below). Measurement based on gel permeation chromatography (GPC) using polystyrene as a standard substance demonstrated that the weight-average molecular weight of the polymer B was 30,000.

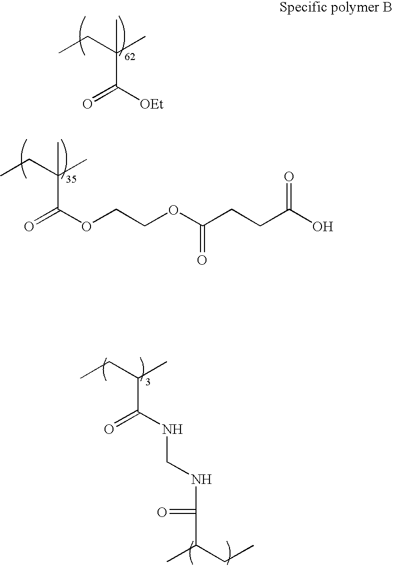

### Synthesis Examples 3 to 16

### Synthesis of Specific Polymers C to P

Specific polymers C to P (having structures illustrated below) were synthesized in the same way as in Synthesis Example 1 or 2 except that the starting materials therein were changed to monomers constituting the respective polymers. Hereinafter, a case in which the polymer was synthesized in the same way as in Synthesis Example 1 will be described and referred to as “Synthesis process A” and a case in which the polymer was synthesized in the same way as in Synthesis Example 2 will be described and referred to as “Synthesis process B”, shown with the structure of each of the polymers. The molecular weights of the polymers were measured by GPC. The measurement results are also shown together with the structures of the polymers.
Specific Polymer C (Synthesis Process B)

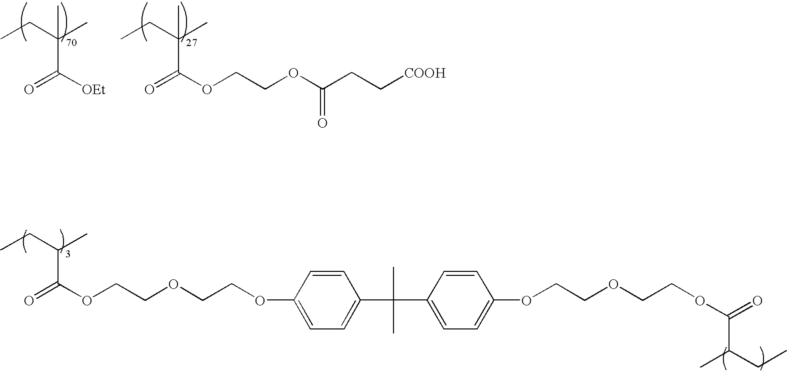

weight-average molecular weight: 60,000
Specific Polymer D (Synthesis Process A) 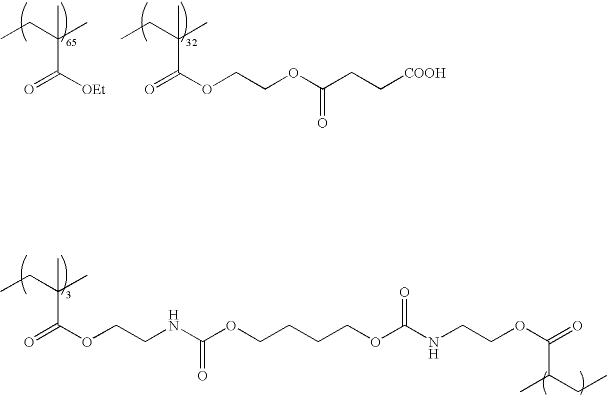
weight-average molecular weight: 120,000
Specific Polymer E (Synthesis process A)

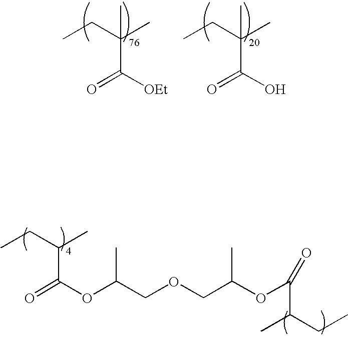

weight-average molecular weight: 140,000
Specific Polymer F (Synthesis Process A)

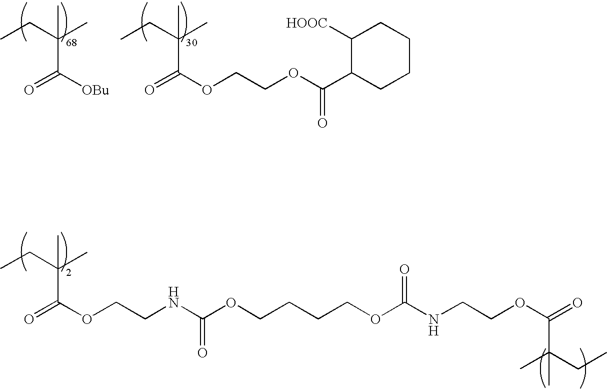

weight-average molecular weight: 130,000
Specific Polymer G (Synthesis Process A)

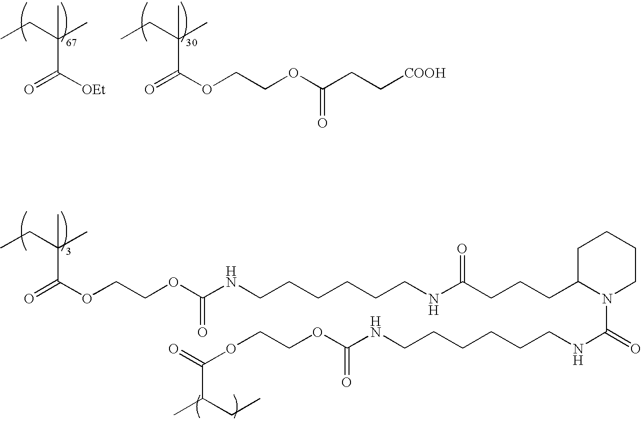

weight-average molecular weight: 150,000
Specific Polymer H (Synthesis Process B)

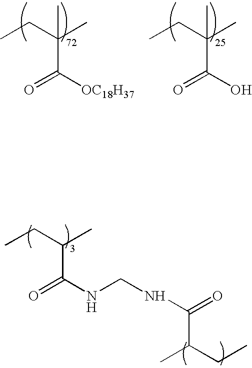

weight-average molecular weight: 40,000
Specific Polymer I (Synthesis Process A)

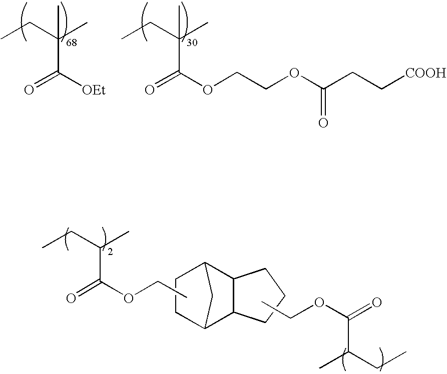

weight-average molecular weight: 110,000
Specific Polymer J (Synthesis Process B)

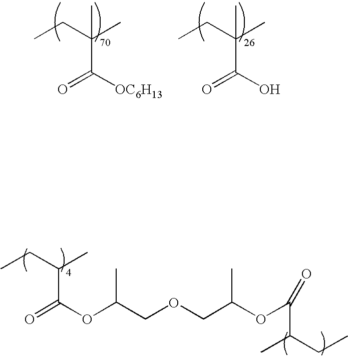

weight-average molecular weight: 120,000
Specific Polymer K (Synthesis Process A)

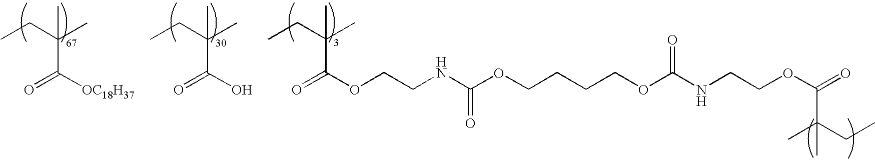

weight-average molecular weight: 150,000
Specific Polymer L (Synthesis Process A)

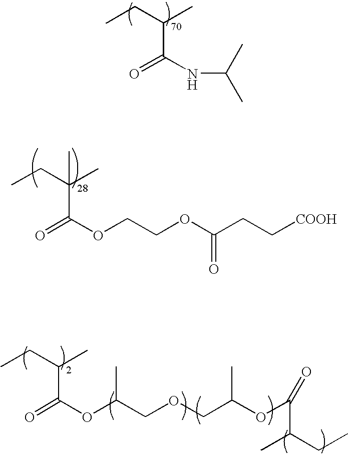

weight-average molecular weight: 200,000
Specific Polymer M (Synthesis Process A)

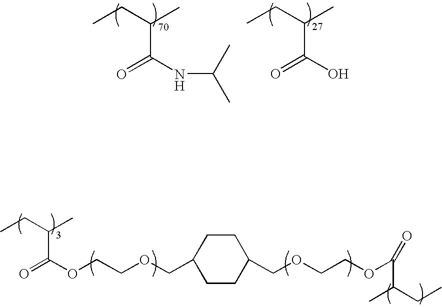

weight-average molecular weight: 220,000
Specific Polymer N (Synthesis Process A)

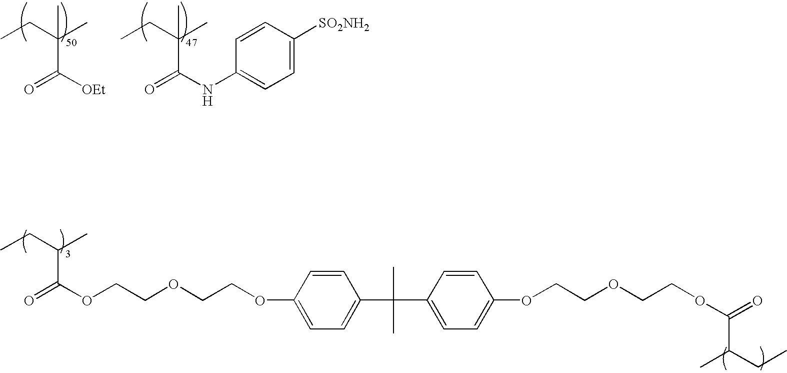

weight-average molecular weight: 180,000
Specific Polymer O (Synthesis Process A)

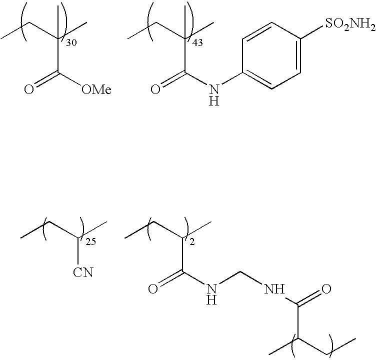

weight-average molecular weight: 110,000
Specific Polymer P (Synthesis Process A)

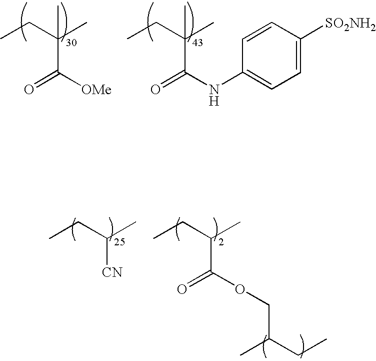

Weight-average molecular weight: 110,000

(Formation of Supports)

JIS-A-1050 aluminum plates having a thickness of 0.3 mm were used to conduct treatment wherein the following steps (a) to (j) were combined, thereby forming supports A, B, C and D.

(a) Mechanical Surface-Roughening Treatment

While a suspension of an abrasive agent (silica sand) having a specific gravity of 1.12 in water was supplied as an abrading slurry onto a surface of any one of the aluminum plates, the surface was mechanically roughened with rotating roller-form nylon brushes. The average grain size of the abrasive agent was 8 μm and the maximum grain size thereof was 50 μm. The material of the nylon brushes was 6-10-nylon, the length of bristles thereof was 50 mm, and the diameter of the bristles was 0.3 mm. The nylon brushes were each obtained by making holes in a stainless steel cylinder having a diameter of 300 mm and then planting bristles densely into the holes. The number of the used rotating brushes was three. The distance between the two supporting rollers (diameter: 200 mm) under each of the brushes was 300 mm. Each of the brush rollers was pushed against the aluminum plate until the load of a driving motor for rotating the brush became 7 kW larger than the load before the brush roller was pushed against the aluminum plate. The rotating direction of the brush was the same as the moving direction of the aluminum plate. The rotation speed of the brush was 200 rpm.

(b) Alkali Etching Treatment

A 70° C. aqueous solution of NaOH (NaOH concentration: 26% by mass, and aluminum ion concentration: 6.5% by mass) was sprayed onto the aluminum plate obtained in the above-mentioned manner to etch the aluminum plate, thereby dissolving the aluminum plate by 6 g/m². Thereafter, the aluminum plate was washed with water.

(c) Desmutting Treatment

The aluminum plate was subjected to desmutting treatment with a 30° C. aqueous solution having a nitric acid concentration of 1% by mass (and containing 0.5% by mass of aluminum ions), which was sprayed, and then washed with water. The aqueous nitric acid solution used in the desmutting treatment was waste liquid derived from the step of conducting electrochemical surface-roughening treatment using alternating current in an aqueous nitric acid solution.

(d) Electrochemical Surface-Roughening Treatment

Alternating current having a frequency of 60 Hz was used to conduct electrochemical surface-roughening treatment continuously. The electrolyte used at this time was a 10.5 g/L solution of nitric acid in water (containing 5 g/L of aluminum ions), and the temperature thereof was 50° C. The wave of the used alternating current was a trapezoidal wave wherein the time TP until the current value was raised from zero to a peak was 0.8 msec, and the duty ratio of the current was 1:1. This trapezoidal wave alternating current was used, and a carbon electrode was set as a counter electrode to conduct the electrochemical surface-roughening treatment. Ferrite was used as an auxiliary anode. The used electrolyte bath was a radial cell type bath.

The density of the current was 30 A/dm² when the current was at the peak. The total amount of consumed electricity when the aluminum plate functioned as an anode was 220 C/dm². Five percent of the current sent from a power source was allowed to flow into the auxiliary anode.

Thereafter, the aluminum plate was washed with water.

(e) Alkali Etching Treatment

An aqueous solution having a caustic soda of 26% by mass and an aluminum ion concentration of 6.5% by mass was sprayed onto the aluminum plate to etch the plate at 32° C. so as to dissolve the aluminum plate by 0.20 g/m², thereby removing smut components made mainly of aluminum hydroxide and generated when the alternating current was used to conduct the electrochemical surface-roughening treatment in the previous step, and further dissolving edges of formed pits so as to be made smooth. Thereafter, the aluminum plate was washed with water.

(f) Desmut Treatment

The aluminum plate was subjected to desmutting treatment with a 30° C. aqueous solution having a nitric acid concentration of 15% by mass (and containing 4.5% by mass of aluminum ions), which was sprayed, and then washed with water. The aqueous nitric acid solution used in the desmutting treatment was waste liquid derived from the step of conducting the electrochemical surface-roughening treatment using the alternating current in the aqueous nitric acid solution.

(g) Electrochemical Surface-Roughening Treatment

Alternating current having a frequency of 60 Hz was used to conduct electrochemical surface-roughening treatment continuously. The electrolyte used at this time was a 7.5 g/L solution of hydrochloric acid in water (containing 5 g/L of aluminum ions), and the temperature thereof was 35° C. The wave of the alternating current was a rectangular wave. A carbon electrode was set as a counter electrode to conduct the electrochemical surface-roughening treatment. Ferrite was used as an auxiliary anode. The used electrolyte bath was a radial cell type bath.

The density of the current was 25 A/dm² when the current was at the peak. The total amount of consumed electricity when the aluminum plate functioned as an anode was 50 C/dm².

Thereafter, the aluminum plate was washed with water.

(h) Alkali Etching Treatment

An aqueous solution having a caustic soda of 26% by mass and an aluminum ion concentration of 6.5% by mass was sprayed onto the aluminum plate to etch the plate at 32° C. so as to dissolve the aluminum plate by 0.10 g/m², thereby removing smut components made mainly of aluminum hydroxide and generated when the alternating current was used to conduct the electrochemical surface-roughening treatment in the previous step, and further dissolving edges of formed pits so as to be made smooth. Thereafter, the aluminum plate was washed with water.

(i) Desmutting Treatment

The aluminum plate was subjected to desmutting treatment with a 60° C. aqueous solution having a sulfuric acid concentration of 25% by mass (and containing 0.5% by mass of aluminum ions), which was sprayed, and then washed with water.

(j) Anodizing Treatment

As electrolytes, sulfuric acid was used. The electrolytes were each an electrolyte having a sulfuric acid concentration of 170 g/L (and containing 0.5% by mass of aluminum ions), and the temperature thereof was 43° C. Thereafter, the support was washed with water.

The current densities were each about 30 A/dm². The final amount of the oxidation film was 2.7 g/m².

<Support A>

The above steps (a) to (j) were successively performed and the etching amount in step (e) was set to 3.5 g/m², so as to form a support A.

<Support B>

The above-mentioned steps other than steps (g), (h) and (i) were successively performed to form a support B.

<Support C>

The above-mentioned steps other than steps (a), (g), (h) and (i) were successively performed to form a support C.

<Support D>

The above-mentioned steps other than the steps (a), (g), (h) and (i) were successively performed, and the total amount of consumed electricity in step (g) was set to 450 C/dm², to form a support D.

The supports A, B, C and D obtained in the above-mentioned manner were subjected to the following treatment to make the support surface hydrophilic and apply undercoat to the support.

(k) Treatment with Alkali Metal Silicate

Each of the aluminum supports A to D obtained in the above-mentioned manner was immersed into a treatment tank containing a 30° C. aqueous solution of #3 sodium silicate (concentration of sodium silicate: 1% by mass) for 10 seconds to subject the support to treatment with the alkali metal silicate (silicate treatment). Thereafter, the support was washed with water. The amount of the silicate adhering at this time was 3.5 mg/m².

(Undercoat Treatment)

An undercoat solution having the following composition was applied onto each of the aluminum supports treated with the alkali metal silicate, which supports were obtained in the above-mentioned manner, and the resultant was dried at 80° C. for 15 seconds. The applied amount of solid contents after the drying was 14 mg/m².

<Undercoat Solution Composition>

| | | |
|---|---|---|
| Polymer compound having a structure illustrated below | 0.3 | g |
| Methanol | 100 | g |
| Water | 1.0 | g |
| weight-average molecular weight | 18,000 | |

| | |
|---|---|
| 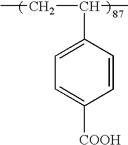 | 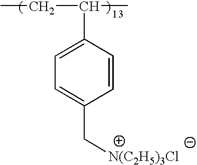 |

| | |
|---|---|
| Weight-average molecular weight: | 180,000 |

### Example 1

A recording layer coating solution 1 described below was applied onto the support C, on which the undercoat layer was formed, in such a manner that the applied amount of the solution would be 1.0 g/m² after the solution would be dried. Thereafter, in a dryer PERFECT OVEN PH 200 manufactured by Tabai Co., with its Wind Control being set to 7, was used to dry the support at 140° C. for 50 seconds, thereby forming a recording layer. In this way, a positive type planographic printing plate precursor of Example 1 was obtained.

<Recording Layer Coating Solution 1>

| | |
|---|---|
| Specific polymer A (as the specific polymer (B)) | 0.28 g |
| m,p-Cresol Novolak | 0.474 g |
| (containing 0.5% by weight of unreacted cresol, | |
| mole ratio of m-cresol/p-cresol = 6/4, | |
| weight-average molecular weight: 3500) | |
| Copolymer 1 | 2.37 g |
| (having a composition described below) | |
| Infrared absorbent IR-1 | 0.155 g |
| (as the infrared absorbent (A)) having | |
| a structure illustrated below | |
| 2-Methoxy-4- | 0.03 g |
| (N-phenylamino)benzenediazonium | |
| hexafluorophosphate | |
| Tetrahydrophthalic anhydride | 0.19 g |
| Dye wherein the counter ion of | 0.05 g |
| Ethyl Violet was changed to | |
| 6-hydroxy-β-naphthalenesulfonic acid ion | |
| Fluorine-containing surfactant | 0.035 g |
| (trade name: MEGAFAC F176PF, manufactured by | |
| Dainippon Ink & Chemicals, Inc. | |
| (solid content: 20% by mass)) | |
| p-Toluenesulfonic acid | 0.008 g |
| Bis-p-hydroxyphenylsulfone | 0.063 g |
| γ-Butyrolactone | 13 g |
| Methyl ethyl ketone | 24 g |
| 1-Methoxy-2-propanol | 11 g |

<Copolymer 1>

N-(p-aminosulfonylphenyl)methacrylamide/ethyl methacrylate/acrylonitrile (32/43/25% by mole). The weight-average molecular weight thereof was 53,000. The synthesis process thereof is described in JP-A No. 11-288093.

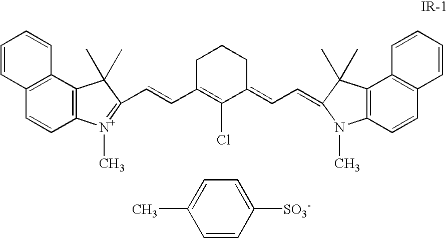

### Examples 2 to 4

The above-mentioned undercoat layer was formed on each of the supports described in Table 1, and the following recording layer coating solution 2 was applied onto the undercoat such that the amount of the applied solution after being dried would be 1.8 g/m². Thereafter, the resultant was dried under the same conditions as in Example 1, so as to form a recording layer. In this way, planographic printing plate precursors of Examples 2 to 4 were obtained.

<Recording Layer Coating Solution 2>

| | |
|---|---|
| Specific polymer A (as the specific polymer (B)) | 0.09 g |
| Novolak resin | 0.90 g |
| (containing 0.5% by weight of unreacted cresol, | |
| mole ratio of m-cresol/p-cresol = 6/4, | |
| weight-average molecular weight: 7000) | |
| Ethyl methacrylate/isobutyl methacrylate/ | 0.10 g |
| methacrylic acid copolymer (35/35/30% by mole) | |
| Infrared absorbent IR-1 | 0.1 g |
| (as the infrared absorbent (A)) having | |
| the structure illustrated above | |
| Phthalic anhydride | 0.05 g |
| p-Toluenesulfonic acid | 0.002 g |
| Dye wherein the counter ion of | 0.02 g |
| Ethyl Violet was changed to | |
| 6-hydroxy-β-naphthalenesulfonic acid ion | |
| Fluorine-containing polymer | 0.015 g |
| (trade name: DEFENSA F-176, manufactured by | |
| Dainippon Ink & Chemicals, Inc. | |
| (solid content: 20% by mass)) | |
| Fluorine-containing polymer | 0.035 g |
| (trade name: DEFENSA MCF-312, | |
| manufactured by Dainippon Ink & Chemicals, Inc. | |
| (solid content: 30% by mass)) | |
| Methyl ethyl ketone | 12 g |

### Examples 5 to 19

Planographic printing plate precursors of Examples 5 to 19 were obtained in the same manner as in Example 1 except that the specific polymer A as the specific polymer (B) in the recording layer coating solution 1 was changed to each described in Table 1.

### Comparative Example 1

A planographic printing plate precursor of Comparative Example 1 was obtained in the same manner as in Example 1 except that none of the specific polymer A as the specific polymer (B) was added to the recording layer coating solution 1.

### Comparative Example 2

A planographic printing plate precursor of Comparative Example 2 was obtained in the same manner as in Example 2 except that none of the specific polymer A as the specific polymer (B) was added to the recording layer coating solution 2.

TABLE 1

| | | | Development | | | |
|---|---|---|---|---|---|---|
| | Planographic | | latitude (mS/cm) | | | |
| | printing plate | Specific | Developer | Developer | Scratch | |
| | precursor | polymer | A | B | resistance (g) | Support |
| Example 1 | 1 | A | 8.0 | 8.0 | 8 | C |
| Example 2 | 2 | A | 8.0 | 7.5 | 8 | C |
| Example 3 | 3 | A | 8.0 | 7.5 | 8 | D |
| Example 4 | 4 | A | 8.0 | 7.5 | 8 | A |
| Example 5 | 5 | B | 8.0 | 7.5 | 8 | C |
| Example 6 | 6 | C | 8.0 | 8.0 | 8 | C |
| Example 7 | 7 | D | 8.0 | 8.0 | 8 | C |
| Example 8 | 8 | E | 8.0 | 8.0 | 8 | C |
| Example 9 | 9 | F | 8.0 | 8.0 | 8 | C |
| Example 10 | 10 | G | 8.0 | 7.5 | 8 | C |
| Example 11 | 11 | H | 7.0 | 7.5 | 7 | C |
| Example 12 | 12 | I | 7.0 | 7.0 | 7 | C |
| Example 13 | 13 | J | 7.0 | 7.5 | 7 | C |
| Example 14 | 14 | K | 7.0 | 7.5 | 7 | C |
| Example 15 | 15 | L | 7.5 | 7.5 | 8 | C |
| Example 16 | 16 | M | 7.5 | 7.5 | 8 | C |
| Example 17 | 17 | N | 7.5 | 7.5 | 7 | C |
| Example 18 | 18 | O | 7.5 | 7.5 | 7 | C |
| Example 19 | 19 | P | 7.5 | 7.5 | 6 | C |
| Comparative | 20 | Not added | 6.0 | 6.5 | 2 | C |
| Example 1 | | | | | | |
| Comparative | 21 | Not added | 6.0 | 6.5 | 3 | C |
| Example 2 | | | | | | |

### Examples 20 to 22

The above-mentioned undercoat layer was formed on each of the supports described in Table 2, and the following recording layer coating solution 3 was applied onto the undercoat layer with a bar coater in such a manner that the amount of the applied solution would be 0.85 g/m² after the solution would be dried. Thereafter, the resultant was dried at 178° C. for 33 seconds. Immediately thereafter, the resultant was cooled with cool air of 17 to 20° C. until the temperature of the support reached 35° C. Subsequently, the following recording layer coating solution 4 was applied onto the recording layer with a bar coater in such a manner that the amount of the applied solution would be 0.22 g/m². Thereafter, the resultant was dried at 149° C. for 20 seconds, and cooled with cool air of 20 to 26° C. to obtain each of planographic printing plate precursors of Examples 20 to 22 each having a recording layer of a double-layer structure.

<Recording Layer Coating Solution 3>

| | |
|---|---|
| N-(4-aminosulfonylphenyl)methacrylamide/ | 2.133 g |
| acrylonitrile/methyl methacrylate copolymer | |
| (36/34/30% by mole, | |
| weight-average molecular weight: 50000, acid value: 2.65) | |
| Infrared absorbent IR-1 | 0.109 g |
| (as the infrared absorbent (A)) | |
| having the structure illustrated above | |
| 4,4′-Bishydroxyphenylsulfone | 0.126 g |
| Tetrahydrophthalic anhydride | 0.190 g |
| p-Toluenesulfonic acid | 0.008 g |
| 3-Methoxy-4- | 0.030 g |
| diazodiphenylamine hexafluorophosphate | |
| Dye wherein the counter ion of | 0.100 g |
| Ethyl Violet was changed to | |
| 6-hydroxy-β-naphthalenesulfonic acid ion | |
| Fluorine-containing surfactant | 0.035 g |
| (trade name: MEGAFAC F176, manufactured by | |
| Dainippon Ink & Chemicals, Inc. | |
| (solid content: 20% by mass)) | |
| Methyl ethyl ketone | 25.38 g |
| 1-Methoxy-2-propanol | 13.0 g |
| γ-Butyrolactone | 13.2 g |
| <Recording layer coating solution 4> | |
| m,p-Cresol Novolak | 0.3478 g |
| (containing 0.8% by weight of unreacted cresol, | |
| mole ratio of m-cresol/p-cresol = 6/4, | |
| weight-average molecular weight: 4500) | |
| Infrared absorbent IR-1 | 0.0192 g |
| (as the infrared absorbent (A)) | |
| having the structure illustrated above | |
| Specific polymer A (as the specific polymer (B)) | 0.034 g |
| Ammonium compound used | 0.0115 g |
| in Example 2 in JP-A No. 2001-398047 | |
| Fluorine-containing surfactant | 0.022 g |
| (trade name: MEGAFAC F176, manufactured by | |
| Dainippon Ink & Chemicals, Inc. | |
| (solid content: 20% by mass)) | |
| Methyl ethyl ketone | 13.07 g |
| 1-Methoxy-2-propanol | 6.79 g |

### Example 23

A planographic printing plate precursor of Example 23 having a recording layer with a double-layer structure was obtained in the same way as in Example 20 except that a recording layer coating solution 5 having the following composition was used instead of the recording layer coating solution 3 and further a recording layer coating solution 6 having the following composition was used instead of the recording layer coating solution 4.

<Recording Layer Coating Solution 5>

| | |
|---|---|
| N-(4-aminosulfonylphenyl)methacrylamide/ | 2.133 g |
| acrylonitrile/methyl methacrylate copolymer | |
| (36/34/30% by mole, | |
| weight-average molecular weight: 50000, acid value: 2.65) | |
| Infrared absorbent IR-1 | 0.109 g |
| (as the infrared absorbent (A)) | |
| having the structure illustrated above | |
| 4,4′-Bishydroxyphenylsulfone | 0.126 g |
| Tetrahydrophthalic anhydride | 0.190 g |
| p-Toluenesulfonic acid | 0.008 g |
| 3-Methoxy-4- | 0.030 g |
| diazodiphenylamine hexafluorophosphate | |
| Dye wherein the counter ion of | 0.100 g |
| Ethyl Violet was changed to | |
| 6-hydroxy-β-naphthalenesulfonic acid ion | |
| Fluorine-containing surfactant | 0.035 g |
| (trade name: MEGAFAC F176, | |
| manufactured by Dainippon Ink & Chemicals, Inc. | |
| (solid content: 20% by mass)) | |
| Methyl ethyl ketone | 25.38 g |
| 1-Methoxy-2-propanol | 13.0 g |
| γ-Butyrolactone | 13.2 g |
| <Recording layer coating solution 6> | |
| m,p-Cresol Novolak | 0.3478 g |
| (containing 0.8% by weight of unreacted cresol, | |
| mole ratio of m-cresol/p-cresol = 6/4, | |
| weight-average molecular weight: 4500) | |
| Infrared absorbent IR-1 | 0.0192 g |
| (as the infrared absorbent (A)) | |
| having the structure illustrated above | |
| Specific polymer A (as the specific polymer (B)) | 0.034 g |
| Ammonium compound used | 0.0115 g |
| in Example 2 in JP-A No. 2001-398047 | |
| Fluorine-containing surfactant | 0.022 g |
| (trade name: MEGAFAC F176, manufactured by | |
| Dainippon Ink & Chemicals, Inc. | |
| (solid content: 20% by mass)) | |
| Methyl ethyl ketone | 13.07 g |
| 1-Methoxy-2-propanol | 6.79 g |

### Examples 24 to 37

Each of planographic printing plate precursors of Examples 23 to 37 was obtained in the same way as in Example 20 except that the specific polymer A (as the specific polymer (B)) used in the recording layer coating solution 4 was changed to each described in Table 2.

### Comparative Example 3

A planographic printing plate precursor of Comparative Example 3 was obtained in the same way as in Example 20 except that none of the specific polymer A (as the specific polymer (B)) was not added to the recording layer coating solution 4.

TABLE 2

| | | | Development | | | |
|---|---|---|---|---|---|---|
| | Planographic | | latitude (mS/cm) | | | |
| | printing plate | Specific | Developer | Developer | Scratch | |
| | precursor | polymer | A | B | resistance (g) | Support |
| Example 20 | 23 | A | 9.0 | 8.5 | 10 | A |
| Example 21 | 24 | A | 9.0 | 9.0 | 9 | B |
| Example 22 | 25 | A | 9.0 | 9.0 | 10 | D |
| Example 23 | 26 | B | 9.0 | 8.5 | 10 | A |
| Example 24 | 27 | C | 9.0 | 9.0 | 10 | A |
| Example 25 | 28 | D | 9.0 | 9.0 | 10 | A |
| Example 26 | 29 | E | 9.0 | 9.0 | 10 | A |
| Example 27 | 30 | F | 9.0 | 9.0 | 10 | A |
| Example 28 | 31 | G | 9.0 | 8.5 | 10 | A |
| Example 29 | 32 | H | 8.0 | 8.5 | 8 | A |
| Example 30 | 33 | I | 8.0 | 8.0 | 8 | A |
| Example 31 | 34 | J | 8.0 | 8.5 | 8 | A |
| Example 32 | 35 | K | 8.0 | 8.5 | 8 | A |
| Example 33 | 36 | L | 8.5 | 8.5 | 9 | A |
| Example 34 | 37 | M | 8.5 | 8.5 | 9 | A |
| Example 35 | 38 | N | 8.5 | 8.5 | 8 | A |
| Example 36 | 39 | O | 8.5 | 8.5 | 8 | A |
| Example 37 | 40 | P | 8.5 | 8.5 | 8 | A |
| Comparative | 41 | Not added | 5.5 | 6.6 | 2 | A |
| Example 3 | | | | | | |

[Evaluation of the Planographic Printing Plate Precursors of Examples 1 to 37 and Comparative Examples 1 to 3
1. Scratch Resistance Evaluation

A scratch tester manufactured by HEIDON Co. was used to scratch the surface of each of the resultant planographic printing plate precursors, under application of a load to its sapphire (tip diameter: 1.0 mm). Immediately thereafter, a PS processor LP940H, wherein a developer DT-2 (diluted to a ratio of 1/8 with water) manufactured by Fuji Photo Film Co., Ltd. and a finisher FG-1 (diluted to a ratio of 1/1 with water) manufactured by Fuji Photo Film Co., Ltd. were charged, was used to develop the planographic printing plate precursor for a developing time of 12 seconds while the temperature of the solutions was kept at 30° C. At this time, the electric conductivity of the developer was 43 mS/cm. The load at which a scratch was not observed any more with the naked eye was defined as the value of the scratch resistance of the planographic printing plate precursor. The larger the value, the better the scratch resistance. The results also are shown in Tables 1 and 2.

2. Development Latitude Evaluation

Each of the resultant planographic printing plate precursors was stored at a temperature of 25° C. and a relative humidity of 50% for 5 days, and then a TRENDSETTER 3244 manufactured by Creo Co. was used to draw a test pattern imagewise into the precursor at a beam intensity of 9.0 W and a drum rotation rate of 150 rpm.

Thereafter, an alkaline developer A or B having the following composition was diluted with water while the amount of water was variously changed. The resultant diluted developers had various electric conductivities. These were separately charged into a PS processor 900H manufactured by Fuji Photo Film Co., Ltd. While the temperature of the charged solution was kept at 30° C., the planographic printing plate precursor was developed for 22 seconds. At this time, the following was defined as the development latitude of the planographic printing plate precursor: the difference between the highest value and the lowest value of electric conductivities of the developers making satisfactory development possible without dissolving image portions or generating any stain or color resulting from a residue of the recording layer resulted from unsatisfactory development. In this case, the larger the difference, the better the development latitude. The results also are shown in Tables 1 and 2.

<Alkaline developer A composition>

| | |
|---|---|
| SiO₂.K₂O (K₂O/SiO₂ = 1/1 (ratio by mole)) | 4.0% by mass |
| Citric acid | 0.5% by mass |
| Polyethylene glycol lauryl ether | 0.5% by mass |
| (weight-average molecular weight: 1,000) | |
| water | 95.0% by mass |

<Alkaline developer B composition>

| | |
|---|---|
| D sorbit | 2.5% by mass |
| Sodium hydroxide | 0.85% by mass |
| Polyethylene glycol lauryl ether | 0.5% by mass |
| (weight-average molecular weight: 1,000) | |
| Water | 96.15% by mass |

As is evident from Tables 1 and 2, the planographic printing plate precursors of Examples 1 to 37 according to the invention were excellent in scratch resistance and development latitude regardless that the structure of their recording layer was monolayered or multilayered.

On the other hand, the planographic printing plate precursor of Comparative Example 1, corresponding to Example 1 wherein the specific polymer A was not added, and that of Comparative Example 2, corresponding to Example 2 wherein the specific polymer A was not added, were poor in scratch resistance.

The planographic printing plate precursor of Comparative Example 3, corresponding to Example 20 wherein the specific polymer A was not added, was poor in development latitude and scratch resistance.

The above-mentioned examples demonstrate that the image recording material of the invention is useful as the recording layer of positive type planographic printing plate precursors to which infrared rays can be applied.

1. A heat mode image recording material, comprising:
an infrared absorbent (A); and
a polymer (B) comprising a polyfunctional monomer component,
the material being modified when exposed by an infrared laser, whereby an image can be formed thereon.

2. A heat mode image recording material according to claim 1, wherein the polyfunctional monomer component of the polymer (B) is a compound having 2 or more terminal ethylenic unsaturated groups which can undergo radical polymerization reaction.

3. A heat mode image recording material according to claim 2, wherein the polyfunctional monomer component of the polymer (B) has 2 terminal ethylenic unsaturated groups which can undergo radical polymerization reaction.

4. A heat mode image recording material according to claim 2, wherein the polyfunctional monomer component is a compound represented by general formula (I): 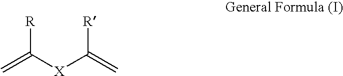
wherein R and R′ each independently represent a hydrogen atom or a methyl group; and X represents a bivalent linking group.

5. A heat mode image recording material according to claim 4, wherein the bivalent linking group is selected from the group consisting of a normal, branched or cyclic alkyl group having 1 to 20 carbon atoms, a normal, branched or cyclic alkenyl group having 2 to 20 carbon atoms, an alkynyl group having 2 to 20 carbon atoms, a (monocyclic or heterocyclic) aryl group having 6 to 20 carbon atoms, —C(═O)N—, —OC(═O)N—, —NC(═O)N—, —SC(═O)N—, —C(═S)—, —OC(═S)—, —NC(═S)—, —SC(═S)—, —O—, —C(═O)O—, —C(═O)—, —S—, —SO₂—, —SO₃—, —SO₂N—, —NH—, —NR¹—, —NAr—, —N═N—, and —N(═NH)N—, wherein R¹ represents an alkyl, alkenyl or alkynyl, Ar represents a (monocyclic or heterocyclic) aryl.

6. A heat mode image recording material according to claim 2, wherein the polyfunctional monomer component is a compound represented by general formula (II): 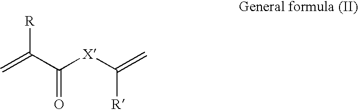
wherein R and R′ each independently represent a hydrogen atom or a methyl group; and X′ represents a bivalent linking group.

7. A heat mode image recording material according to claim 6, wherein the bivalent linking group is selected from the group consisting of a normal, branched or cyclic alkyl group having 1 to 20 carbon atoms, a normal, branched or cyclic alkenyl group having 2 to 20 carbon atoms, an alkynyl group having 2 to 20 carbon atoms, a (monocyclic or heterocyclic) aryl group having 6 to 20 carbon atoms, —C(═O)N—, —OC(═O)N—, —NC(═O)N—, —SC(═O)N—, —C(═S)—, —OC(═S)—, —NC(═S)—, —SC(═S)—, —O—, —C(═O)O—, —C(═O)—, —S—, —SO₂—, —SO₃—, —SO₂N—, —NH—, —NR¹—, —NAr—, —N═N—, and —N(═NH)N—, wherein R¹ represents an alkyl, alkenyl or alkynyl, Ar represents a (monocyclic or heterocyclic) aryl.

8. A heat mode image recording material according to claim 2, wherein the polyfunctional monomer component is a compound represented by general formula (III): 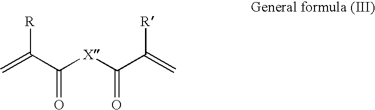
wherein R and R′ each independently represent a hydrogen atom or a methyl group; and X″ represents a bivalent linking group.

9. A heat mode image recording material according to claim 8, wherein the bivalent linking group is selected from the group consisting of a normal, branched or cyclic alkyl group having 1 to 20 carbon atoms, a normal, branched or cyclic alkenyl group having 2 to 20 carbon atoms, an alkynyl group having 2 to 20 carbon atoms, a (monocyclic or heterocyclic) aryl group having 6 to 20 carbon atoms, —C(═O)N—, —OC(═O)N—, —NC(═O)N—, —SC(═O)N—, —C(═S)—, —OC(═S)—, —NC(═S)—, —SC(═S)—, —O—, —C(═O)O—, —C(═O)—, —S—, —SO₂—, —SO₃—, —SO₂N—, —NH—, —NR¹—, —NAr—, —N═N—, and —N(═NH)N—, wherein R¹ represents an alkyl, alkenyl or alkynyl, Ar represents a (monocyclic or heterocyclic) aryl.

10. A heat mode image recording material according to claim 2, wherein the polyfunctional monomer component is a compound represented by general formula (IV): 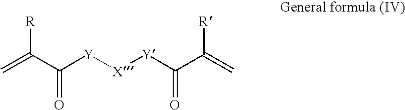
wherein R and R′ each independently represent a hydrogen atom or a methyl group; X′″ represents a bivalent linking group; and Y and Y′ each independently represent an oxygen atom or NR² wherein R² represents a hydrogen atom or an alkyl group.

11. A heat mode image recording material according to claim 10, wherein the bivalent linking group is selected from the group consisting of a normal, branched or cyclic alkyl group having 1 to 20 carbon atoms, a normal, branched or cyclic alkenyl group having 2 to 20 carbon atoms, an alkynyl group having 2 to 20 carbon atoms, a (monocyclic or heterocyclic) aryl group having 6 to 20 carbon atoms, —C(═O)N—, —OC(═O)N—, —NC(═O)N—, —SC(═O)N—, —C(═S)—, —OC(═S)—, —NC(═S)—, —SC(═S)—, —O—, —C(═O)O—, —C(═O)—, —S—, —SO₂—, —SO₃—, —SO₂N—, —NH—, —NR¹—, —NAr—, —N═N—, and —N(═NH)N—, wherein R¹ represents an alkyl, alkenyl or alkynyl, Ar represents a (monocyclic or heterocyclic) aryl.

12. A heat mode image recording material according to claim 1, wherein the polymer (B) is a homopolymer made from the polyfunctional monomer component, or a copolymer made from the polyfunctional monomer component and a different copolymerization component.

13. A heat mode image recording material according to claim 1, wherein the polymer (B) is a mixture of a homopolymer made from the polyfunctional monomer component and at least one alkali-soluble resin which is different from the homopolymer.

14. A heat mode image recording material according to claim 13, wherein the homopolymer made from the polyfunctional monomer component is contained at a ratio of 2.0 to 70% by mass, with respect to a total amount of the alkali-soluble resin(s).

15. A heat mode image recording material according to claim 14, wherein the homopolymer made from the polyfunctional monomer component is contained at a ratio of 5.0 to 60% by mass, with respect to a total amount of the alkali-soluble resin(s).

16. A heat mode image recording material, comprising:
an infrared absorbent (A); and
an alkali-soluble resin (B) comprising at least a copolymer made from a polyfunctional monomer component having 2 or more terminal ethylenic unsaturated groups which can undergo radical polymerization reaction, and a different copolymerization component,
the material being modified when exposed by an infrared laser, whereby an image can be formed thereon.

17. A heat mode image recording material according to claim 16, wherein the polyfunctional monomer component is a compound represented by any one of general formulae (I) to (IV). 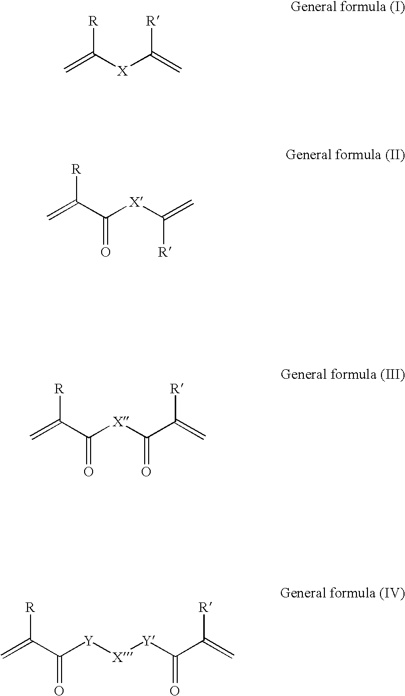
in General formula (I) to (IV), R and R′ each independently represent a hydrogen atom or a methyl group; X, X′, X″ and X′″ each independently represent a bivalent linking group; and Y and Y′ each independently represent an oxygen atom or NR² wherein R² represents a hydrogen atom or an alkyl group.

18. A heat mode image recording material, comprising:
an infrared absorbent (A); and
an alkali-soluble resin (B) comprising at least a homopolymer made from a polyfunctional monomer component having 2 or more terminal ethylenic unsaturated groups which can undergo radical polymerization reaction,
the material being exposed to an infrared laser, whereby an image can be formed.

19. A heat mode image recording material according to claim 18, wherein the polyfunctional monomer component is a compound represented by any one of general formulae (I) to (IV). 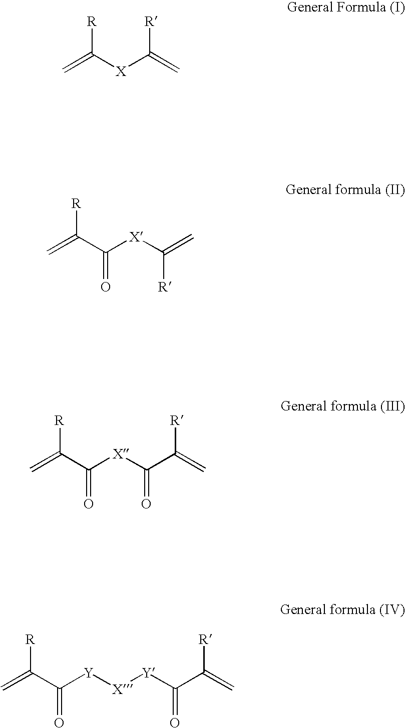
in General formula (I) to (IV), R and R′ each independently represent a hydrogen atom or a methyl group; X, X′, X″ and X′″ each independently represent a bivalent linking group; and Y and Y′ each independently represent an oxygen atom or NR² wherein R² represents a hydrogen atom or an alkyl group.

20. A heat mode image recording material according to claim 18, wherein the homopolymer made from the polyfunctional monomer component is contained at a ratio of 2.0 to 70% by mass of the resin, with respect to a total amount of the alkali-soluble resin.
